(19) United States
(12) Patent Application Publication
(10) Pub. No.: US 2024/0290018 A1
(43) Pub. Date: Aug. 29, 2024

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventors: KOUTA MURASAWA, Kanagawa (JP); TAKAYUKI YAMADA, Kanagawa (JP); KAZUYA OGASAWARA, Kanagawa (JP); KAZUFUMI KONDO, Kanagawa (JP); SHINJIRO HORI, Kanagawa (JP)

(21) Appl. No.: 18/584,943

(22) Filed: Feb. 22, 2024

(30) Foreign Application Priority Data
Feb. 24, 2023 (JP) 2023-026875

(51) Int. Cl. G06T 11/60; G06F 3/04845; G06F 3/04847

(52) U.S. Cl. CPC G06T 11/60; G06F 3/04845; G06F 3/04847; G06T 2200/24

(57) ABSTRACT

An image and a character are input, designation of a target impression by a user is accepted via a ring-shaped user interface (UI), and a poster is generated based on the image, the character, and the target impression.

### BACKGROUND

### Field of the Disclosure

The present disclosure relates to an information processing apparatus, a control method thereof, and a storage medium.

### Description of the Related Art

Methods for generating a poster by preparing a template storing information about the shapes and arrangement of images, characters, and graphics constituting a poster in advance and automatically arranging images, characters, and graphics on the template have heretofore been discussed.

Japanese Patent No. 6537419 discusses generating posters by selecting templates in ascending order of differences between impression assessment values of the templates and those of an image.

According to Japanese Patent No. 6537419, a template with a small difference between its impression assessment values and those of the image is selected. However, generating a poster expressing a user-intended impression is not taken into account at all.

### SUMMARY

The present disclosure is directed to generating a poster expressing a user-intended impression with appropriate and simple operation.

According to an aspect of the present disclosure, an information processing apparatus includes an image input unit configured to input an image, a character input unit configured to input a character, an acceptance unit configured to accept designation of a target impression by a user, and a poster generation unit configured to generate a poster based on the image, the character, and the target impression. The acceptance unit is configured to accept the designation of the target impression by the user via a ring-shaped operation user interface (UI).

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration of a poster generation apparatus.

FIG. 2 is a software block diagram of a poster generation application.

FIGS. 3A and 3B are diagrams for illustrating a skeleton.

FIG. 4 is a chart for illustrating coloration patterns.

FIG. 5 is a diagram illustrating a display screen provided by the poster generation application.

FIG. 6 is a diagram illustrating a display screen provided by the poster generation application.

FIG. 7 is a flowchart illustrating poster impression quantization processing.

FIG. 8 is a diagram for illustrating subjective assessment of a poster.

FIGS. 9A and 9B are flowcharts illustrating poster generation processing.

FIGS. 10A to 10C are diagrams for illustrating a method for selecting a skeleton.

FIGS. 11A and 11B are charts for illustrating a method for selecting a coloration pattern and a font pattern.

FIG. 12 is a software block diagram for illustrating a layout unit in detail.

FIG. 13 is a flowchart illustrating layout processing.

FIGS. 14A to 14C are charts for illustrating input of the layout unit.

FIGS. 15A to 15C are diagrams for illustrating operation of the layout unit.

FIGS. 16A to 16D are diagrams illustrating examples of a user interface (UI) for setting a target impression.

FIG. 17 is a software block diagram of a poster generation application.

FIG. 18 is a flowchart illustrating poster generation processing.

FIGS. 19A to 19D are charts for illustrating a combination generation unit.

FIGS. 20A and 20B are charts for illustrating the combination generation unit.

FIG. 21 is a flowchart illustrating display processing in the poster generation processing.

FIG. 22 is a flowchart illustrating poster generation processing.

FIGS. 23A and 23B are diagrams illustrating examples of a poster preview screen.

FIG. 24 is a display screen provided by the poster generation application.

FIGS. 25A and 25B are diagrams for illustrating impression terms for a poster.

FIGS. 26A to 26F are diagrams for illustrating generated posters.

FIGS. 27A to 27C are diagrams for illustrating generated posters.

FIG. 28 is a table for illustrating a relationship between impression terms and design elements.

FIG. 29 is a flowchart illustrating poster generation processing.

### DESCRIPTION OF THE EMBODIMENTS

Exemplary embodiments of the present disclosure will be described in detail below with reference to the accompanying drawings. The following exemplary embodiments are not intended to limit the present disclosure set forth in the claims, and all combinations of features described in the exemplary embodiments are not necessarily essential to the solving means of the present disclosure. Similar components are denoted by the same reference numerals, and a description thereof will be omitted.

A first exemplary embodiment will be described by using a method for automatically generating a poster by running an application (hereinafter, also referred to as an “app”) for generating a poster on a poster generation apparatus as an example. In the following description, “images” include both still images and frame images extracted from a moving image unless otherwise specified.

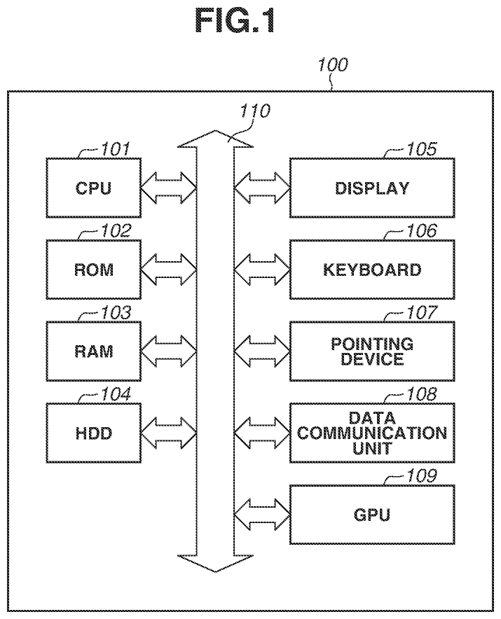

FIG. 1 is a block diagram illustrating a hardware configuration of a poster generation apparatus 100. The poster generation apparatus 100 is an information processing apparatus. Examples thereof include a personal computer (PC) and a smartphone. In the present exemplary embodiment, the poster generation apparatus 100 is described as a PC. The poster generation apparatus 100 includes a central processing unit (CPU) 101, a read-only memory (ROM) 102, a random access memory (RAM) 103, a hard disk drive (HDD) 104, a display 105, a keyboard 106, a pointing device 107, a data communication unit 108, and a graphics processing unit (GPU) 109.

The CPU (processor) 101 controls the poster generation apparatus 100 in a comprehensive manner, and implements the operation of the present exemplary embodiment by reading a program stored in the ROM 102 into the RAM 103 and executing the program, for example. While FIG. 1 illustrates one CPU, the poster generation apparatus 100 may include a plurality of CPUs.

The ROM 102 is a general-purpose ROM, and stores programs to be executed by the CPU 101, for example. The RAM 103 is a general-purpose RAM, and used as a working memory for temporarily storing various types of information when the CPU 101 executes a program, for example.

The HDD 104 is a storage medium (storage unit) for storing image files, a database that stores results of image analysis process and other processes, and skeletons to be used by a poster generation application.

The display 105 is a display unit for displaying a user interface (UI) according to the present exemplary embodiment and electronic posters that are layout results of image data (hereinafter, also referred to as “images”) to the user. The keyboard 106 and the pointing device 107 accept instruction operations from the user. The display 105 may have a touch sensor function.

The keyboard 106 is used when the user inputs the number of spreads of the poster to be generated to the UI displayed on the display 105, for example.

The pointing device 107 is used when the user clicks on a button on the UI displayed on the display 105, for example.

The data communication unit 108 communicates with an external apparatus via a wired or wireless network. For example, the data communication unit 108 transmits data laid out with an automatic layout function to a printer or server that is capable of communicating with the poster generation apparatus 100.

A data bus 110 communicably connects the blocks illustrated in FIG. 1 to each other.

The configuration illustrated in FIG. 1 is just an example and not restrictive. For example, the poster generation apparatus 100 may be without the display 105, and display its UI on an external display.

The poster generation application according to the present exemplary embodiment is stored in the HDD 104. The poster generation application is activated by the user performing a click or double-click operation on the application icon displayed on the display 105 with the pointing device 107.

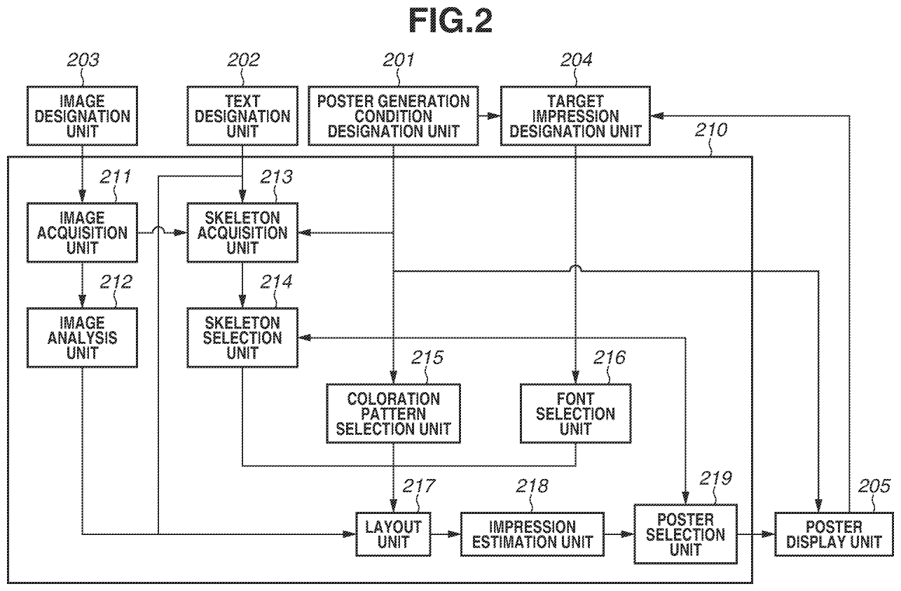

FIG. 2 is a software block diagram of the poster generation application. The poster generation application includes a poster generation condition designation unit 201, a text designation unit 202, an image designation unit 203, a target impression designation unit 204, a poster display unit 205, and a poster generation unit 210. The poster generation unit 210 includes an image acquisition unit 211, an image analysis unit 212, a skeleton acquisition unit 213, a skeleton selection unit 214, a coloration pattern selection unit 215, a font selection unit 216, a layout unit 217, an impression estimation unit 218, and a poster selection unit 219.

If the poster generation application is installed on the poster generation apparatus 100, an activation icon is displayed on a top screen (desktop) of an operating system (OS) running on the poster generation apparatus 100. The user operates (e.g., double-clicks on) the activation icon displayed on the display 105 with the pointing device 107. With the activation icon operated, the program of the poster generation application stored in the HDD 104 is loaded into the RAM 103 and executed by the CPU 101. The poster generation application is thereby activated.

The poster generation application includes program modules corresponding to the respective components illustrated in FIG. 2. The CPU 101 executes the program modules, so that the CPU 101 functions as the components illustrated in FIG. 2. In the following description of the components illustrated in FIG. 2, the components are described to perform various types of processing. In particular, FIG. 2 illustrates a software block diagram related to the poster generation unit 210 that performs the automatic poster generation function.

The poster generation condition designation unit 201 designates a poster generation condition for the poster generation unit 210 based on UI operations using the pointing device 107. In the present exemplary embodiment, a poster size and a use application category are designated as the poster generation condition. The poster size may be designated in terms of actual width and height values, or in terms of a sheet size such as A1 and A2. The use application category refers to a category indicating for what use application the poster is used. Examples include a restaurant, a school event, and a sale.

The text designation unit 202 designates character information to be arranged on the poster with UI operations using the keyboard 106. Examples of the character information to be arranged on the poster include character strings indicating a title, a date and time, and a place. The text designation unit 202 links each piece of character information with the type of information, such as a title, a date and time, and a place for the sake of distinction, and outputs the pieces of character information linked with the types of information to the skeleton acquisition unit 213 and the layout unit 217.

The image designation unit 203 designates one or more pieces of image data to be arranged on the poster, stored in the HDD 104. The image data may be designated based on the structure of the file system including the image data, such as a device and a directory. The image data may be designated by accessory information for identifying images, such as an imaging date and time, or by attribute information. The image designation unit 203 outputs the file path(s) of the designated image(s) to the image acquisition unit 211.

The target impression designation unit 204 designates the target impression of the poster to be generated. The target impression refers to a final impression for the generated poster to produce. There are two patterns of designation methods. A first pattern is to designate an initially set impression as the target impression. The initially set impression may be determined based on the category designated by the poster generation condition designation unit 201. In such a case, the poster generation condition designation unit 201 designates the category, and then the target impression designation unit 204 designates predetermined target impression values.

A second pattern is to designate a target impression that is reset by the poster display unit 205 to be described below based on user operations. When the poster generation application is activated or if no target impression reset by using the poster display unit 205 is stored in the RAM 103, the target impression designation unit 204 designates the initially set impression values as the target impression.

If a target impression reset by the poster display unit 205 is stored in the RAM 103, the target impression designation unit 204 designates the stored target impression. In the present exemplary embodiment, intensities indicating the degrees of impression of impression-expressing words are designated as the target impression. Information indicating the target impression designated by the target impression designation unit 204 is shared with the skeleton selection unit 214, the coloration pattern selection unit 215, the font selection unit 216, and the poster selection unit 219. Details of the impression will be described below.

Next, a configuration of the poster generation unit 210 will be described in detail.

The image acquisition unit 211 acquires one or more pieces of image data designated by the image designation unit 203 from the HDD 104. The image acquisition unit 211 outputs the acquired image data to the image analysis unit 212. The image acquisition unit 211 also outputs the number of acquired images to the skeleton acquisition unit 213. Examples of the images stored in the HDD 104 include still images and frame images extracted from a moving image. The still images and the frame images are acquired from an imaging device, such as a digital camera and a smart device. The imaging device may be included in the poster generation apparatus 100 or an external apparatus. If the imaging device is an external device, the image is acquired via the data communication unit 108. Other examples of the still images include illustrations generated by image editing software and computer graphics (CG) images generated by CG creation software. The still images and the frame images may be images acquired from a network or server via the data communication unit 108. Examples of the images acquired from a network or server include social media images (hereinafter, referred to as social networking service [SNS] images). Programs executed by the CPU 101 analyze data accompanying each image and determine the storage location of the image. For example, SNS images may be acquired from the social media via an application, and the storage locations may be managed inside the application. The images are not limited to the foregoing, and other types of images may be used.

The image analysis unit 212 performs image data analysis processing on the image data acquired from the image acquisition unit 211 using a method to be described below, and acquires information indicating an image feature amount to be described below. Specifically, the image analysis unit 212 performs object recognition processing to be described below to acquire information indicating the image feature amount of the image data. The image analysis unit 212 links the image data with the acquired information indicating the image feature amount, and outputs the image data linked with the information to the layout unit 217.

The skeleton acquisition unit 213 acquires one or more skeletons matching conditions designated by the poster generation condition designation unit 201, the text designation unit 202, and the image acquisition unit 211 from the HDD 104. In the present exemplary embodiment, a skeleton refers to information about the arrangement of character strings, images, and graphics on a poster.

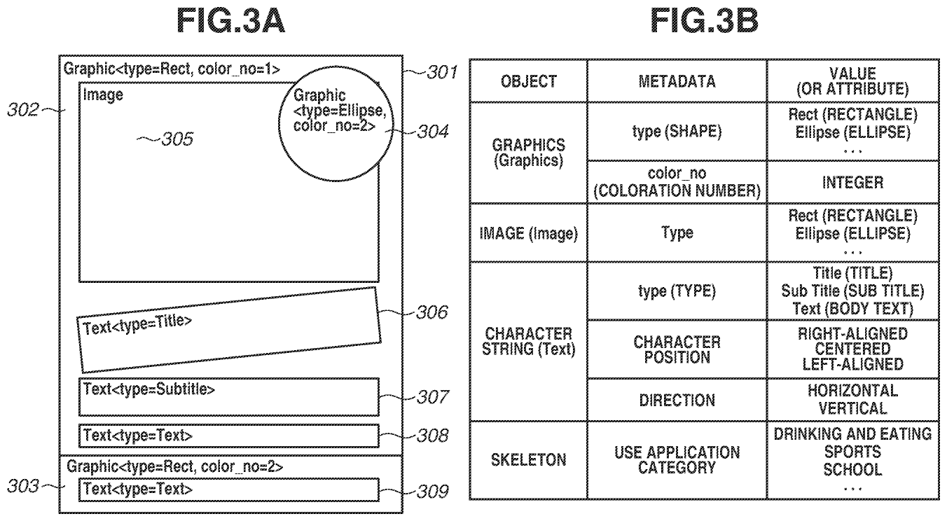

FIGS. 3A and 3B are diagrams illustrating an example of a skeleton. In FIG. 3A, three graphic objects 302, 303, and 304, an image object 305, and four character-arranged objects or character objects 306, 307, 308, and 309 are arranged on a skeleton 301. For each object, metadata to be used for generating the poster is recorded in addition to a position, a size, and an angle that indicate the location where the object is arranged. FIG. 3B is a chart illustrating examples of the metadata. For example, the character objects 306 to 309 store what type of character information is arranged as a metadata attribute. Here, the character object 306 indicates that a title is arranged there, the character object 307 a subtitle, and the character objects 308 and 309 a body text. The graphic objects 302 to 304 store the shapes of the graphics and coloration numbers (coloration identifiers [IDs]) indicating coloration patterns as metadata. Here, the attributes of the graphic objects 302 and 303 indicate a rectangle, and that of the graphic object 304 an ellipse. The graphic object 302 is assigned coloration number 1, and the graphic objects 303 and 304 coloration number 2. As employed herein, a coloration number is information to be referred to during color allocation to be described below. Different coloration numbers indicate that different colors are allocated. The types and metadata of objects are not limited thereto. For example, a map object for arranging a map or a barcode object for arranging a Quick Response (QR) code (registered trademark) or barcode may be used. A character object may have metadata indicating a vertical spacing and a character spacing. Metadata may describe the use application of the skeleton and be used to control whether the skeleton is available depending on the use application.

Skeletons may be stored in the HDD 104 in a comma-separated values (CSV) format or in a database (DB) format, such as a Structured Query Language (SQL) format, for example. The skeleton acquisition unit 213 outputs the one or more skeletons acquired from the HDD 104 to the skeleton selection unit 214.

The skeleton selection unit 214 selects one or more skeletons matching the target impression designated by the target impression designation unit 204 from among the skeletons acquired from the skeleton acquisition unit 213, and outputs the selected skeleton(s) to the layout unit 217. Since the layout of the entire poster depends on the skeleton, the variety of generated posters can be increased by preparing various types of skeletons in advance.

The coloration pattern selection unit 215 acquires one or more coloration patterns matching the target impression designated by the target impression designation unit 204 from the HDD 104, and outputs the coloration pattern(s) to the layout unit 217. A coloration pattern refers to a combination of colors to be used in a poster.

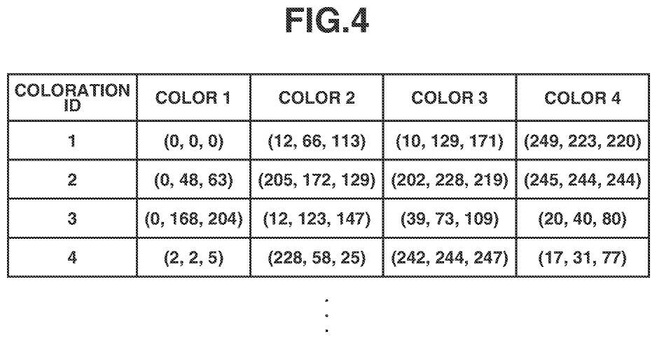

FIG. 4 is a chart illustrating an example of a table of coloration patterns. In the present exemplary embodiment, each coloration pattern is expressed as a combination of four colors. A coloration ID column of FIG. 4 lists IDs for uniquely identifying coloration patterns. Color 1 to color 4 columns each express color in order of red, green, and blue (RGB) with RGB color values of 0 to 255, or (R, G, B)=(0 to 255, 0 to 255, 0 to 255). While coloration patterns expressed by combinations of four colors are used in the present exemplary embodiment, the number of colors may be different. Different numbers of colors may be used together.

The font selection unit 216 selects one or more font patterns matching the target impression designated by the target impression designation unit 204, acquires the selected font pattern(s) from the HDD 104, and outputs the font pattern(s) to the layout unit 217. A font pattern refers to a combination of at least one of the following: a title font, a subtitle font, and a body text font.

The layout unit 217 generates one or more pieces of poster data, the number of which is more than or equal to a designated number of posters to be generated, by laying out various types of data on each of the one or more skeletons acquired from the skeleton selection unit 214. The layout unit 217 arranges the text acquired from the text designation unit 202 and the image data acquired from the image analysis unit 212 on each skeleton. The layout unit 217 then applies the coloration pattern(s) acquired from the coloration pattern selection unit 215, and applies the font pattern(s) acquired from the font selection unit 216. The layout unit 217 outputs the generated one or more pieces of poster data to the impression estimation unit 218.

The impression estimation unit 218 estimates the impression of each piece of poster data acquired from the layout unit 217, and links the estimated impression with the poster data. The impression estimation unit 218 then outputs the one or more pieces of poster data linked with the estimated impression(s) to the poster selection unit 219.

The poster selection unit 219 compares the target impression designated by the target impression designation unit 204 with the estimated impression(s) of the linked one or more pieces of poster data acquired from the impression estimation unit 218, and selects the piece of poster data linked with the estimated impression closest to the target impression. The selection result is stored in the HDD 104. The poster selection unit 219 outputs the selected poster data to the poster display unit 205.

The poster display unit 205 outputs a poster image to be displayed on the display 105 based on the poster data acquired from the poster selection unit 219. An example of the poster image is bitmap data. The poster display unit 205 displays the poster image on the display 105. The poster display unit 205 also displays a ring-shaped operation UI for operating impression. The user can reset impression using this operation UI. If the target impression is reset by the user operating the ring-shaped operation UI for operating impression, the reset target impression is stored in the RAM 103. The reset target impression is used by the target impression designation unit 204.

The poster generation application may have an additional function (not illustrated) of editing the arrangement, color, and shape of images, text, and graphics by the user's additional operation to further modify the poster data to a user-desired design after the display of the generated poster image on the poster display unit 205.

If the poster generation application has a function of printing the poster data stored in the HDD 104 using a printer based on a condition designated by the poster generation condition designation unit 201, the user can obtain a print product of the generated poster.

### Example of Display Screen

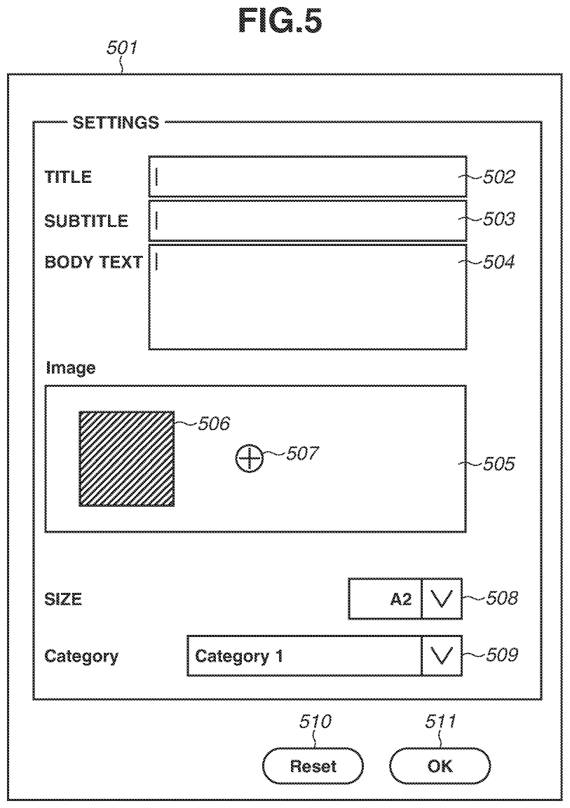

FIG. 5 is a diagram illustrating an example of an app activation screen 501 provided by the poster generation application. The app activation screen 501 is displayed on the display 105. The user sets a poster generation condition to be described below, text, and images via the app activation screen 501. The poster generation condition designation unit 201, the text designation unit 202, and the image designation unit 203 acquire the settings from the user via this UI screen.

A title box 502, a subtitle box 503, and a body text box 504 accept designation of character information to be arranged on the poster. While three types of character information are accepted in the present exemplary embodiment, this is not restrictive. For example, additional character information such as a place and a date and time may be accepted. All the types of character information do not necessarily need to be designated, and some of the boxes may be empty.

An image designation area 505 is used for displaying an image or images to be arranged on the poster. An image 506 is a thumbnail of a designated image. An image addition button 507 is used for adding an image to be arranged on the poster. If the image addition button 507 is pressed by the user, the image designation unit 203 displays a dialog screen for selecting a file stored in the HDD 104 and accepts selection of an image file by the user. The thumbnail of the selected image is then added to the image designation area 505.

A size list box 508 is used for setting the size of the poster to be generated. The size list box 508 displays a list of generatable poster sizes, from which a size can be selected by the user's click operation with the pointing device 107.

A category list box 509 is configured to set a use application category of the poster to be generated.

A reset button 510 is used for resetting the pieces of setting information on the app activation screen 501.

If an OK button 511 is pressed by the user, the poster generation condition designation unit 201, the text designation unit 202, the image designation unit 203, and the target impression designation unit 204 output the settings made on the app activation screen 501 to the poster generation unit 210. Here, the poster generation condition designation unit 201 acquires the size of the poster to be generated from the size list box 508 and the use application category of the poster to be generated from the category list box 509.

The text designation unit 202 acquires character information to be arranged on the poster from the title box 502, the subtitle box 503, and the body text box 504. The image designation unit 203 acquires the file path(s) of the image(s) to be arranged on the poster from the image designation area 505. The target impression designation unit 204 acquires predetermined impression values stored in the ROM 102 or the HDD 104 as a target impression. The poster generation condition designation unit 201, the text designation unit 202, the image designation unit 203, and the target impression designation unit 204 may modify the values set on the app activation screen 501. For example, the text designation unit 202 may remove unwanted blank characters from the beginning or end of the input character information.

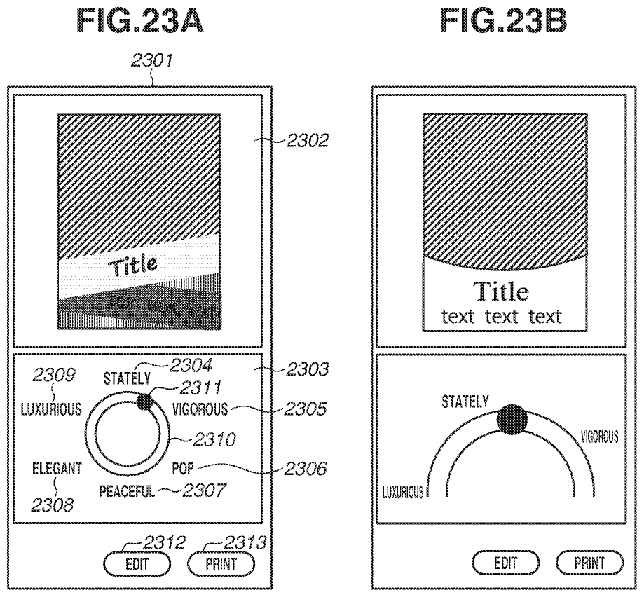

FIG. 23A is a diagram illustrating an example of a poster preview screen displaying a poster image generated by the poster display unit 205 on the display 105. If the OK button 511 on the app activation screen 501 is pressed to complete poster generation, the screen displayed on the display 105 transitions to a poster preview screen 2301.

The poster preview screen 2301 includes a display area 2302 for displaying the generated poster, an impression operation area 2303 including a ring-shaped operation UI for setting the target impression, an edit button 2312, and a print button 2313.

The ring-shaped UI screen for operating the target impression in the impression operation area 2303 will be described.

For example, if slider bars or list boxes are used for respective impression values, the impression values are set one by one. With such a setting method, what kind of impression the generated poster produces is difficult to specifically imagine. Thus, to generate a poster that produces a user-desired impression, the user then repeats operating the impression values and generating a poster. Such operations are tedious to the user. The ring-shaped operation UI enables the user to set a plurality of impression values at a time and eliminates the need for the tedious operations. Moreover, the ring shape enables definition of relative positions. This makes it easy to imagine a change in the generated poster and facilitates operating the impression of the generated poster even if the setting values are greatly changed.

The user sets the impression by moving a setting point 2311 indicating the point where the impression is set. The settable range is on an operation rail 2310. The operation rail 2310 is ring-shaped, and the user can operate the setting point 2311 to go around the operation rail 2310. The user can move the setting point 2311 by a drag-and-drop or touch-and-slide operation. Impression terms 2304 to 2309 expressing the impressions to be set are arranged around the operation rail 2310. Impression terms express impressions the poster gives. FIG. 23A illustrates six impression terms including stately, vigorous, pop, peaceful, elegant, and luxurious. The impression terms are not limited to those illustrated in FIG. 23A, and ones expressing other impressions may be used. The number of impression terms is not limited to six, either, and three or more impression terms may be arranged. If the setting point 2311 is moved by the user operation, the poster display unit 205 resets the target impression.

The edit button 2312 can be used to edit a selected poster using a not-illustrated UI providing an edit function.

The print button 2313 can be used to print a selected poster using a not-illustrated printer control UI.

### <Quantization of Impressions of Posters>

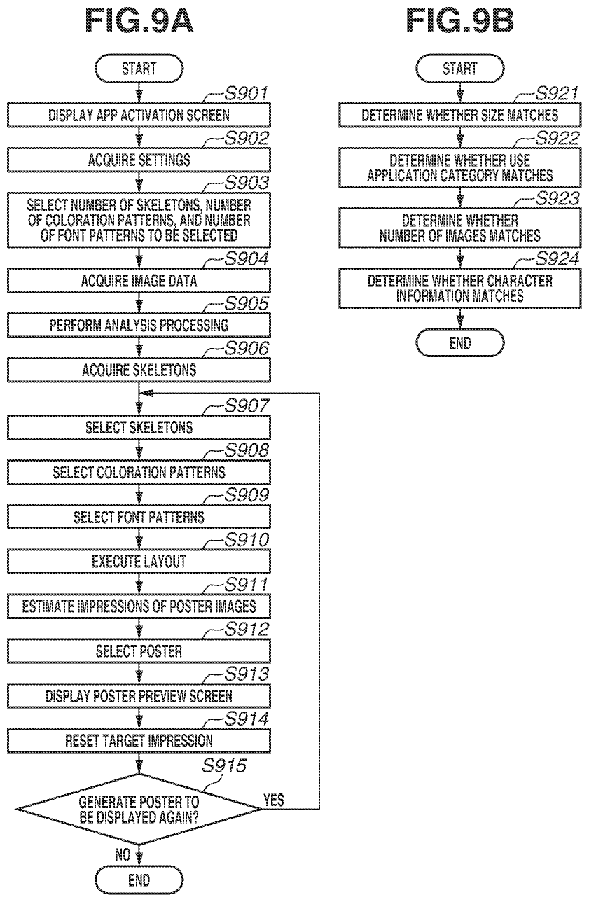

A method of processing for quantizing the impressions of posters will now be described. This processing is preprocessing for performing impression estimation processing to be described below in step S911 of FIG. 9A, which is to be performed for poster generation processing. The processing for quantizing the impressions of posters is performed in the phase of development of the poster generation application by the vendor who develops the poster generation application. The processing for quantizing the impressions of posters may be performed by the poster generation apparatus 100 or an information processing apparatus different from the poster generation apparatus 100. If the processing is performed by an information processing apparatus different from the poster generation application, a CPU of the information processing apparatus performs the processing.

In the processing for quantizing the impressions of posters, impressions that people have of various posters are quantized. At the same time, correspondence between the poster images and the impressions of the posters is derived. This enables estimation of the impression of a poster from a generated poster image. With the impression successfully estimated, the impression of the poster is controllable by modifying the poster image. Moreover, a poster image producing a certain target impression is searchable for. The processing for quantizing the impressions of posters is performed, for example, by running an impression learning application for learning the impressions of poster images on the poster generation apparatus 100 in advance before the poster generation processing.

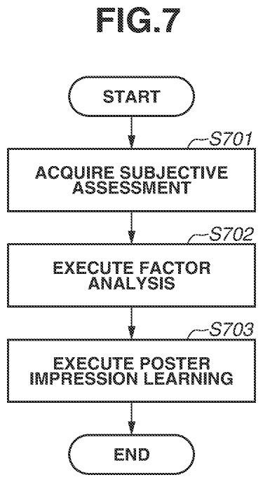

FIG. 7 is a flowchart illustrating the processing for quantizing the impressions of posters. For example, the flowchart illustrated in FIG. 7 is implemented by the CPU 101 reading a program stored in the HDD 104 into the RAM 103 and executing the program. The processing of FIG. 7 is performed.

In step S701, the CPU 101 acquires subjective assessments of impressions about posters.

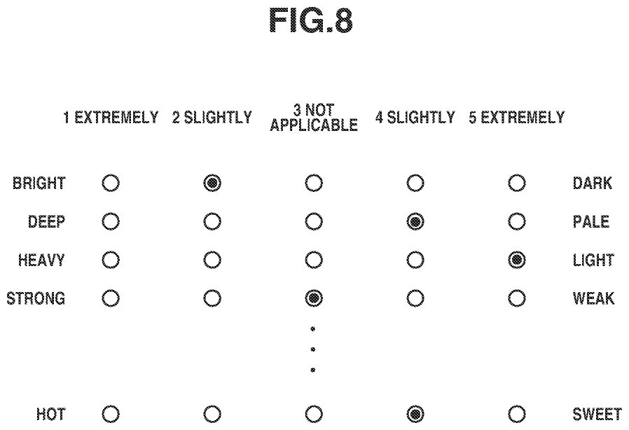

FIG. 8 is a diagram illustrating an example of a subjective assessment method of impressions about posters. The CPU 101 presents posters to subjects and acquires subjective assessments of impressions of the posters from the subjects. Measurement methods such as the semantic difference (SD) method and a Likert scale can be used here. FIG. 8 illustrates an example of a questionnaire using the SD method. The questionnaire is to present pairs of adjectives expressing impressions to a plurality of assessors (subjects) and acquire scores on the adjective pairs the target poster evokes. The CPU 101 acquires subjective assessments on a plurality of posters from a plurality of subjects, and then averages the answers to the respective adjective pairs to set the average to the representative score of the adjective pairs. The technique for the subjective impression assessment may be other than the SD method, as long as terms expressing the impressions and the corresponding scores are determined.

In step S702, the CPU 101 executes a factor analysis of the acquired subjective assessments. The subjective assessments are desirably reduced to an efficient number of dimensions using an analysis technique, such as principal component analysis and factor analysis, since the number of dimensions of the original subjective assessments is as many as the number of adjective pairs and complicates the control. The present exemplary embodiment will be described on the assumption that the dimensions are reduced to four factors through the factor analysis. It will be understood that the number of dimensions varies depending on the selection of adjective pairs for the subjective assessment and the factor analysis technique. The output of the factor analysis shall be normalized. More specifically, each factor is scaled to an average of 0 and a variance of 1 over the posters analyzed. As a result, impressions of −2, −1, 0, +1, and +2 designated by the target impression designation unit 204 simply correspond to impressions of −20, −10, average, +1σ, and +2σ, respectively, which facilitates a distance calculation between a target impression and an estimated impression to be described below. In the present exemplary embodiment, the four factors are a sense of luxury, a sense of intimacy, a sense of vigorousness, and a sense of stateliness illustrated in FIG. 5. These names are given for the sake of convenience in conveying impressions to the user through the UI, and each factor is determined by interrelationship of a plurality of adjective pairs.

In step S703, the CPU 101 associates the poster images with the impressions. While the subjectively assessed posters is quantizable by the foregoing method, the impressions of posters to be generated later are desirably estimated without subjective assessment. The association of the poster images with the impressions is able to be implemented by training a model to estimate an impression from a poster image, using a convolutional neural network (CNN)-based deep learning technique or a decision tree-based machine learning technique, for example. In the present exemplary embodiment, an impression learning unit performs CNN-based supervised deep learning with poster images as inputs and the four factors as outputs. In other words, a deep learning model is trained with the subjectively assessed poster images and the corresponding impressions as correct answers. An unknown poster image is input to the deep learning model to estimate an impression.

The deep learning model generated above is stored in the HDD 104, for example. The impression estimation unit 218 loads the deep learning model stored in the HDD 104 into the RAM 103 and executes the deep learning model.

The impression estimation unit 218 renders poster data acquired from the layout unit 217 into an image, and runs the deep learning model loaded into the RAM 103 on the CPU 101 or the GPU 109 to estimate the impression of the poster. While the deep learning technique is used in the present exemplary embodiment, this is not restrictive. For example, if a decision tree-based machine learning technique is used, feature amounts, such as average luminance values and edge amounts of poster images, may be extracted through image analysis, and a machine learning model to estimate an impression may be generated based on the feature amounts.

FIGS. 9A and 9B are flowcharts illustrating the poster generation processing to be performed by the poster generation unit 210 of the poster generation application. The flowchart illustrated in FIG. 9A is started when the user sets various setting items on the poster generation application and presses the OK button 511 as described above.

The flowcharts illustrated in FIGS. 9A and 9B are implemented by the CPU 101 reading programs stored in the HDD 104 into the RAM 103 and executing the programs.

In the present exemplary embodiment, the components illustrated in FIG. 2, which are run by the CPU 101 executing the foregoing poster generation application, are described to perform the processing. The poster generation processing will be described with reference to FIGS. 9A and 9B.

In step S901, the poster generation application displays the app activation screen 501 on the display 105. The user inputs various settings via the UI screen of the app activation screen 501 using the keyboard 106 and/or the pointing device 107.

In step S902, the poster generation condition designation unit 201, the text designation unit 202, the image designation unit 203, and the target impression designation unit 204 acquire respective corresponding settings from the app activation screen 501. The target impression designation unit 204 may determine the target impression to be set based on the category designated by the poster generation condition designation unit 201.

In step S903, the skeleton selection unit 214, the coloration pattern selection unit 215, and the font selection unit 216 determine the number of skeletons, the number of coloration patterns, and the number of font patterns to be selected, respectively, based on a predetermined number of posters to be generated. In the present exemplary embodiment, the layout unit 217 generates as many pieces of poster data as the number of skeletons×the number of coloration patterns×the number of font patterns by a method to be described below. Here, the number of skeletons, the number of coloration patterns, and the number of font patterns to be selected are determined so that the number of posters to be generated exceeds the number of posters to be generated. In the present exemplary embodiment, the number of skeletons, the number of coloration patterns, and the number of font patterns to be selected are determined the following Eq. 1:

$$Number of items to be selected = ⌈ \sqrt[3]{number of posters to be generated \times 2} ⌉ . \qquad Eq . 1$$

For example, if the number of posters to be generated is 6, the numbers of items to be selected are 3. The layout unit 217 generates 27 pieces of poster data, six of which are selected by the poster selection unit 219.

The poster selection unit 219 can thus select posters producing an overall impression better matching the target impression from among the pieces of poster data generated more than the number of posters to be generated.

In step S904, the image acquisition unit 211 acquires image data. Specifically, the image acquisition unit 211 reads the image file(s) in the HDD 104 designated by the image designation unit 203 into the RAM 103.

In step S905, the image analysis unit 212 performs analysis processing on the image data acquired in step S904, and acquires information indicating a feature amount. Examples of the information indicating the feature amount include meta information included in the image(s) and information indicating an image feature amount obtainable by analyzing the image(s). Such information is used in object recognition processing that is the analysis processing.

In the present exemplary embodiment, the object recognition processing is performed as the analysis processing. However, this is not restrictive, and other types of analysis processing may be performed. The operation in step S905 may even be omitted. Details of the processing performed by the image analysis unit 212 in step S905 will now be described.

The image analysis unit 212 performs the object recognition processing on the image(s) acquired in step S904. A known method can be used for the object recognition processing. In the present exemplary embodiment, objects are recognized using a classifier generated through deep learning. The classifier outputs the likelihood of a pixel constituting an image being a pixel of each object in terms of 0 to 1. An object exceeding a threshold is recognized to be included in the image. The image analysis unit 212 can acquire the type of object, such as a face, a pet like a dog and a cat, a flower, food, a building, a stationary object, and a landmark, and the position of the object by recognizing an object image.

In step S906, the skeleton acquisition unit 213 acquires skeletons matching various setting conditions. In the present exemplary embodiment, each skeleton is described in a skeleton file and stored in the HDD 104. The skeleton acquisition unit 213 reads skeleton files from the HDD 104 into the RAM 103 in order, keeps skeletons matching the setting conditions on the RAM 103, and deletes skeletons not matching the setting conditions from the RAM 103. FIG. 9B is a flowchart of condition determination processing performed by the skeleton acquisition unit 213 here. The condition determination processing of the skeleton acquisition unit 213 will be described with reference to FIG. 9B.

In step S921, the skeleton acquisition unit 213 determines whether the poster size designated by the poster generation condition designation unit 201 matches the size of a skeleton read into the RAM 103. While the matching in size is checked here, only the matching in the aspect ratio may be checked. In such a case, the skeleton acquisition unit 213 enlarges or reduces the coordinate systems of the read skeletons to acquire skeletons matching the poster size designated by the poster generation condition designation unit 201.

In step S922, the skeleton acquisition unit 213 determines whether the use application category designated by the poster generation condition designation unit 201 matches the category of the skeleton. If a skeleton is dedicated to a specific use application, the use application category is described in the skeleton file so that the skeleton will not be acquired unless this use application category is selected. This prevents skeletons specially designed for specific use applications, like one including a graphical pattern suggestive of a school and one including a sports equipment pattern, from being used for other use application categories. If no use application category is set on the app activation screen 501, step S922 is skipped.

In step S923, the skeleton acquisition unit 213 determines whether the number of image objects in the read skeleton matches the number of images acquired by the image acquisition unit 211.

In step S924, the skeleton acquisition unit 213 determines whether the character object(s) in the read skeleton matches/match the character information designated by the text designation unit 202. More specifically, the skeleton acquisition unit 213 determines whether the type(s) of character information designated by the text designation unit 202 is/are included in the skeleton. Suppose, for example, that character strings are designated in the title box 502 and the body text box 504 on the app activation screen 501, and the subtitle box 503 is designated to be empty. In such a case, the skeleton acquisition unit 213 searches all character objects in the skeleton, and if a character object with metadata where “title” is set as the type of character information and a character object with metadata where “body text” is designated are both found, the skeleton acquisition unit 213 determines that the skeleton matches. If not, the skeleton acquisition unit 213 determines that the skeleton does not match.

In such a manner, the skeleton acquisition unit 213 keeps skeletons of which all the skeleton size, the use application category, the number of image objects, and the types of character objects match the setting conditions on the RAM 103. While in the present exemplary embodiment the skeleton acquisition unit 213 checks all the skeleton files on the HDD 104, this is not restrictive. For example, the poster generation application may store a database associating the file paths of the skeletons with search conditions (skeleton size, the use application category, the number of image objects, and the types of character objects) in the HDD 104 in advance. In such a case, the skeleton acquisition unit 213 searches the database and reading only the matching skeleton files from the HDD 104 into the RAM 103, thus acquiring skeleton files at high speed. Return to FIG. 9A.

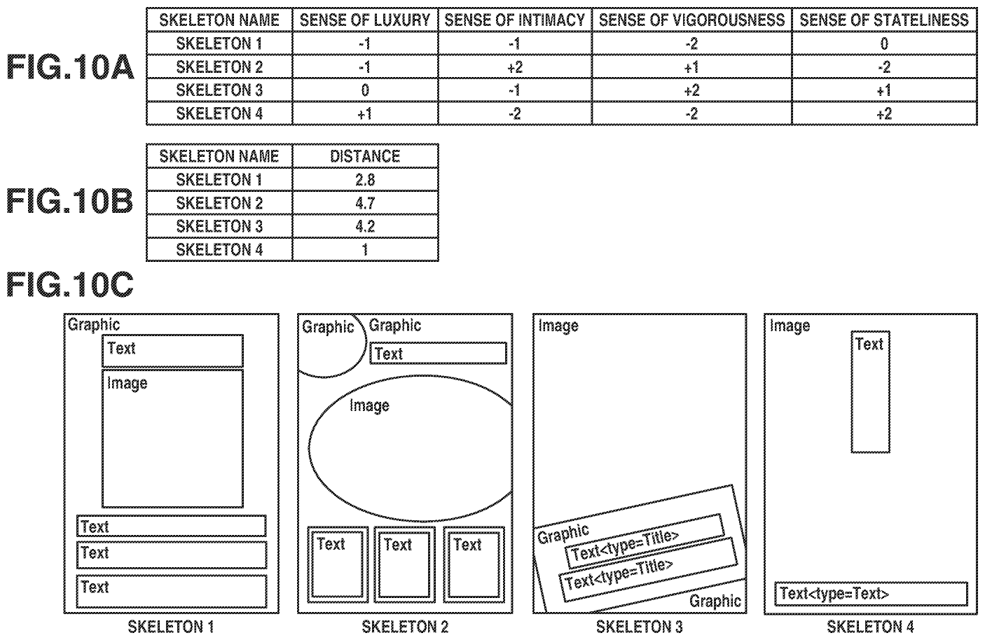

In step S907, the skeleton selection unit 214 selects skeletons matching the target impression designated by the target impression designation unit 204 from the skeletons acquired in step S906. FIGS. 10A to 10C are diagrams for describing a method by which the skeleton selection unit 214 selects skeletons. FIG. 10A is a chart illustrating an example of a table (skeleton impression table) associating skeletons with impressions. A skeleton name column of FIG. 10A lists the filenames of the skeletons. Sense of luxury, sense of intimacy, sense of vigorousness, and sense of stateliness columns of FIG. 10A list numbers (numerical values) indicating to what extent each skeleton affects the respective impressions. The numerical values of −2, −1, 0, +1, and +2 indicate that the impressions are low, somewhat low, neither low nor high, somewhat high, and high, respectively.

The skeleton selection unit 214 initially calculates differences between the target impression acquired from the target impression designation unit 204 and the impressions of the respective skeletons listed in the skeleton impression table of FIG. 10A. Suppose, for example, that the target impression is “a sense of luxury: +1, a sense of intimacy: −1, a sense of vigorousness: −2, a sense of stateliness: +2”. FIG. 10B illustrates distances calculated by the skeleton selection unit 214 in such a case. In the present exemplary embodiment, Euclidean distances are used as the distances (the simple term “distance” will hereinafter refer to a Euclidean distance). The smaller the value indicated by the Euclidean distance, the closer the target impression and the impression of the skeleton. Next, the skeleton selection unit 214 selects top N skeletons in ascending order of the distance values in FIG. 10B. In the present exemplary embodiment, the skeleton selection unit 214 selects top two skeletons. Specifically, the skeleton selection unit 214 selects skeleton 1 and skeleton 4.

Here, N may be a fixed value. N may vary depending on a condition designated by the poster generation condition designation unit 201. For example, if the predetermined number of posters to be generated is six, the poster generation unit 210 generates six posters. The layout unit 217 to be described below generates posters by combining the skeletons, the coloration patterns, and the font patterns selected by the skeleton selection unit 214, the coloration pattern selection unit 215, and the font selection unit 216. For example, if two skeletons, two coloration patterns, and two font patterns are selected, 2×2×2=8 posters can be generated to satisfy the condition that the number of posters to be generated is six. In such a manner, the number N of skeletons to be selected may be determined based on the condition designated by the poster generation condition designation unit 201.

The ranges of the impressions in the skeleton impression table of FIG. 10A do not need to be the same as those of the impression designated by the target impression designation unit 204. In the present exemplary embodiment, the ranges of the impression designated by the target impression designation unit 204 are −2 to +2. The ranges of the impressions in the skeleton impression table may be different. In such a case, the ranges of the skeleton impression table are scaled to those of the target impression before the distance calculation. The distance for the skeleton selection unit 214 to calculate is not limited to a Euclidean distance. Any vector-to-vector distance, such as a Manhattan distance and cosine similarity, can be calculated. An impression for which the target impression is set to off is excluded from the distance calculation.

For example, poster images are generated based on the respective skeletons with the coloration pattern, the font pattern, and the images and character data to be arranged on the skeletons fixed, and the impressions thereof are estimated so that the skeleton impression table is generated in advance. The generated skeleton impression table is stored in the HDD 104. In other words, characteristics relative to other skeletons are tabulated by estimating the impressions of the respective poster images where the character color and images are the same but the characters and images are differently arranged. Here, processing for cancelling impressions ascribable to the used coloration patterns and images is desirably performed by normalizing all the estimated impressions or averaging the impressions of a plurality of poster images generated from a skeleton using a plurality of coloration patterns and images. The effects of the arrangements on the impression, like the impression of a skeleton including a small image is determined by elements such as graphics and characters regardless of the image, and tilted images and characters give a strong sense of vigorousness, can thereby be tabulated. FIG. 10C illustrates examples of skeletons corresponding to skeleton 1 to skeleton 4 of FIG. 10A. For example, skeleton 1 including a regular array of an image object and character objects with a small image area gives a less sense of vigorousness. Skeleton 2 with a circular graphic object and a circular image object gives a high sense of intimacy and a low sense of stateliness. Skeleton 3 with a large image object and a tilted graphic object overlapping the image object gives a strong sense of vigorousness. Skeleton 4 including an image over the entire skeleton with minimum character objects gives a strong sense of stateliness and a low sense of vigorousness. If poster images include characters or images, poster images of different target impressions are thus generated depending on the arrangement of the characters or images. The method for generating the skeleton impression table is not limited thereto. Impressions may be estimated from the features of the arrangement information themselves, such as the areas and coordinates of images and title character strings. Estimated impressions may be manually adjusted. The skeleton impression table is stored in the HDD 104, and the skeleton selection unit 214 reads the skeleton impression table from the HDD 104 into the RAM 103 and refers to the skeleton impression table.

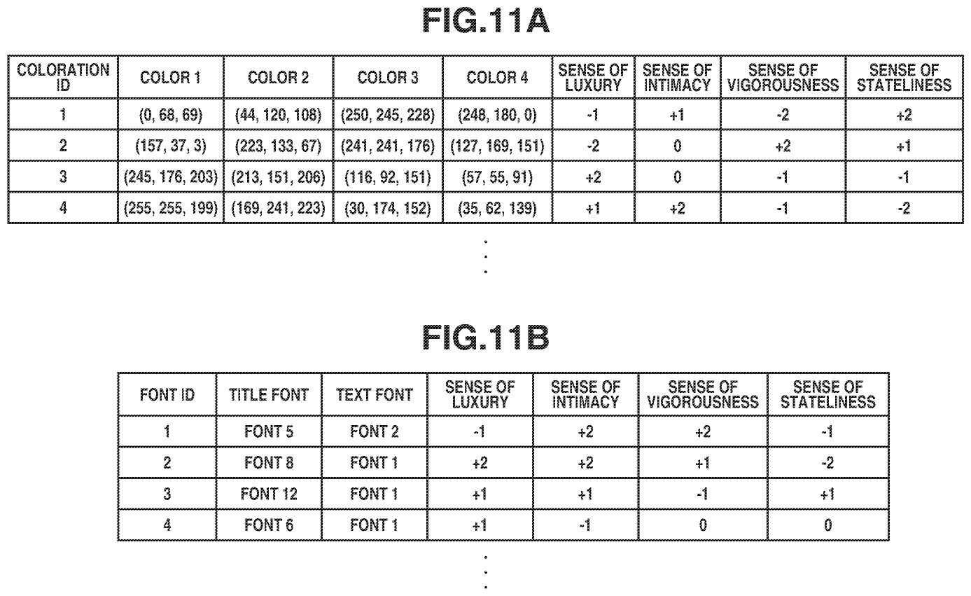

In step S908, the coloration pattern selection unit 215 selects coloration patterns matching the target impression designated by the target impression designation unit 204. The coloration pattern selection unit 215 refers to an impression table corresponding to coloration patterns (coloration pattern impression table) and selects coloration patterns based on the target impression, with a method similar to that of step S906. FIG. 11A illustrates an example of the coloration pattern impression table linking coloration patterns with impressions. The coloration pattern selection unit 215 calculates distance values between the impressions indicated by sense of luxury to sense of stateliness columns of FIG. 11A and the target impression, and selects top N color patterns in ascending order of the distance values. In the present exemplary embodiment, top two coloration patterns are selected. As in the skeleton impression table, posters with different coloration patterns are generated with the skeleton, fonts, and images other than the coloration pattern fixed, and impressions are estimated so that the coloration pattern impression table is able to tabulate the impression tendency of the coloration patterns.

In step S909, the font selection unit 216 selects font combinations (font patterns) matching the target impression designated by the target impression designation unit 204. The font selection unit 216 refers to an impression table corresponding to font patterns (font impression table) and selects font patterns based on the target impression, using a method similar to that of step S906. FIG. 11B illustrates an example of the font impression table linking font patterns with impressions. The font selection unit 216 calculates distance values between the impressions indicated by sense of luxury to sense of stateliness columns of FIG. 11B and the target impression, and selects top N font patterns in ascending order of the distance values. As in the skeleton impression table, posters with different font patterns are generated with the skeleton, coloration pattern, and images other than the font pattern fixed, and impressions are estimated so that the font impression table is able to tabulate the impression tendency of the font patterns.

In step S910, the layout unit 217 sets the character information, images, coloration, and fonts to the skeletons selected by the skeleton selection unit 214 to generate posters.

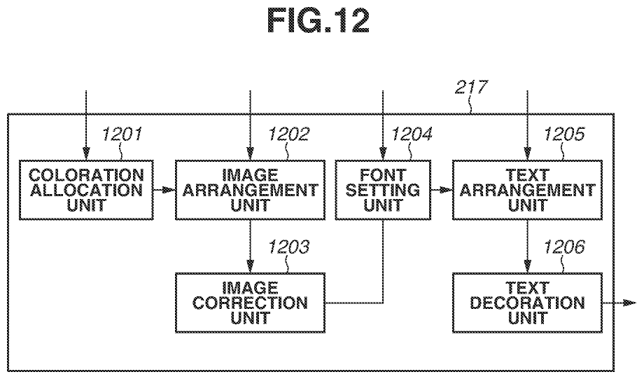

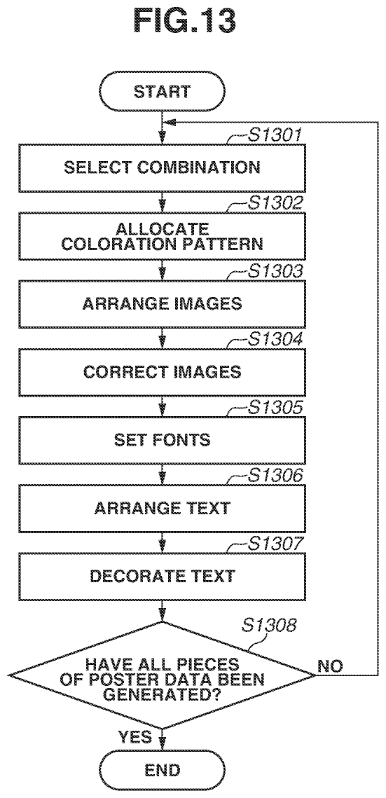

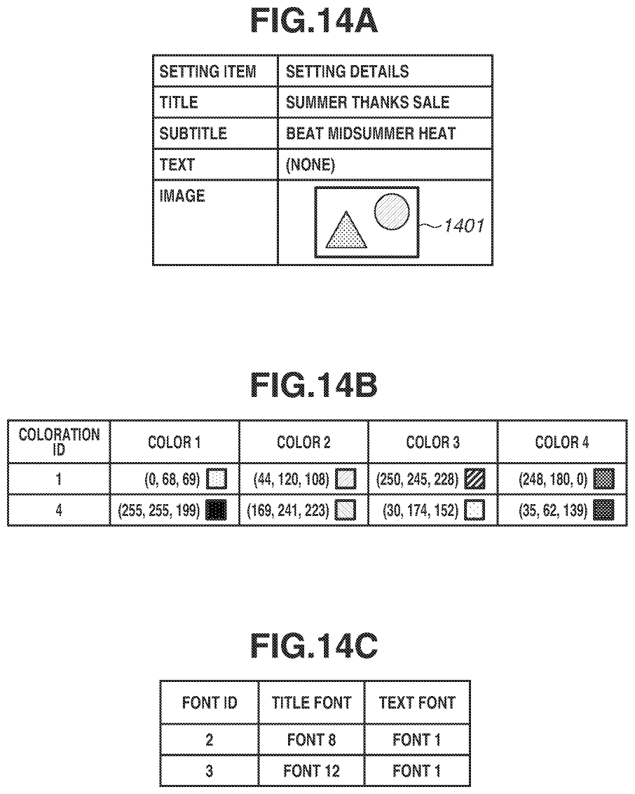

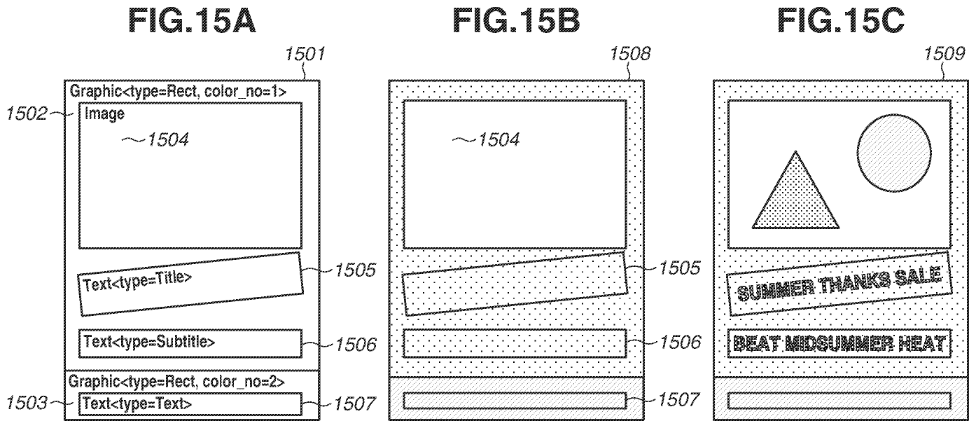

Next, the operation in step S910 and the layout unit 217 will be described in detail with reference to FIGS. 12, 13, 14A to 14C, and 15A to 15C. FIG. 12 is an example of a software block diagram for illustrating the layout unit 217 in detail. The layout unit 217 includes a coloration allocation unit 1201, an image arrangement unit 1202, an image correction unit 1203, a font setting unit 1204, a text arrangement unit 1205, and a text decoration unit 1206. FIG. 13 is a flowchart for illustrating step S910 in detail. FIGS. 14A to 14C are charts for illustrating information input to the layout unit 217. FIG. 14A is a table of character information designated by the text designation unit 202 and an image designated by the image designation unit 203. FIG. 14B is an example of a table listing the coloration patterns acquired from the coloration pattern selection unit 215. FIG. 14C is an example of a table listing the font patterns acquired from the font selection unit 216. FIGS. 15A to 15C are diagrams for illustrating the processing process of the layout unit 217.

Step S910 will initially be described in detail with reference to FIG. 13.

In step S1310, the layout unit 217 enumerates all combinations of the skeletons acquired from the skeleton selection unit 214, the coloration patterns acquired from the coloration pattern selection unit 215, and the font patterns acquired from the font selection unit 216. The layout unit 217 generates poster data on each of the combinations in order through the following layout processing. Suppose, for example, that the number of skeletons acquired from the skeleton selection unit 214 is three, the number of coloration patterns acquired from the coloration pattern selection unit 215 is two, and the number of font patterns acquired from the font selection unit 216 is two, the layout unit 217 generates 3×2×2=12 pieces of poster data. In step S1301, the layout unit 217 selects one of the enumerated combinations and performs the operations in steps S1302 to S1307.

In step S1302, the coloration allocation unit 1201 allocates the coloration pattern acquired from the coloration pattern selection unit 215 to the skeleton acquired from the skeleton selection unit 214.

FIG. 15A is a diagram illustrating an example of a skeleton. In the present exemplary embodiment, an example of allocating the coloration pattern having a coloration ID of 1 in FIG. 14B to a skeleton 1501 of FIG. 15A will be described. The skeleton 1501 of FIG. 15A includes two graphic objects 1502 and 1503, an image object 1504, and three character objects 1505, 1506, and 1507. The coloration allocation unit 1201 initially allocates colors to the graphic objects 1502 and 1503. Specifically, the coloration allocation unit 1201 allocates respective corresponding colors in the coloration pattern to the graphic objects 1502 and 1503 based on coloration numbers that are metadata described in the graphic objects 1502 and 1503. The coloration allocation unit 1201 then allocates, for example, the last color in the coloration pattern to the character object of which the metadata is type and the attribute is “Title” among the character objects. More specifically, in the present exemplary embodiment, the characters arranged in the character object 1505 are allocated color 4. Next, the coloration allocation unit 1201 sets the character color of the characters arranged in the character objects of which the metadata is type and the attribute is other than “Title” among the character objects based on the brightness of the background of the character objects. In the present exemplary embodiment, if the brightness of the background of the character object is lower than or equal to a threshold, the character color is set to white. If not, the character color is set to black. FIG. 15B is a diagram illustrating the state of a skeleton 1508 after the foregoing coloration allocation processing. The coloration allocation unit 1201 outputs the coloration-allocated skeleton data to the image arrangement unit 1202.

In step S1303, the image arrangement unit 1202 arranges the image data acquired from the image analysis unit 212 on the skeleton data acquired from the coloration allocation unit 1201 based on accompanying analysis information. In the present exemplary embodiment, the image arrangement unit 1202 allocates image data 1401 to the image object 1504 in the skeleton. If the image object 1504 and the image data 1401 have different aspect ratios, the image arrangement unit 1202 trims the image data 1401 to adjust the aspect ratio of the image data 1401 to that of the image object 1504. More specifically, the image arrangement unit 1202 trims the image data 1401 so that a decrease in the object area due to the trimming is minimized, based on an object position obtained by the image analysis unit 212 analyzing the image data 1401. The trimming method is not limited thereto, and other trimming methods may be used. For example, the image data 1401 may be trimmed in the middle. The composition may be changed so that a face position fits to a triangular composition. The image arrangement unit 1202 outputs the image-allocated skeleton data to the image correction unit 1203.

In step S1304, the image correction unit 1203 acquires the image-allocated skeleton data from the image arrangement unit 1202, and corrects the image(s) arranged on the skeleton. In the present exemplary embodiment, if an image has insufficient resolution, the image correction unit 1203 upsamples the image through super-resolution processing. The image correction unit 1203 initially determines whether each image arranged on the skeleton satisfies a specific resolution. For example, suppose that a 1600-px-by-1200-px image is allocated to a 200-mm-by-150-mm area on the skeleton. In such a case, the print resolution of the image can be calculated by using Eq. 2:

$$\frac{1600}{200 \div 25.4} \approx 203 [ dpi ] . \qquad Eq . 2$$

If the print resolution of the image is determined to be lower than a threshold, the image correction unit 1203 increases the resolution through super-resolution processing. If the print resolution of the image is higher than or equal to the threshold and determined to be sufficient, the image correction unit 1203 does not correct the image in particular. In the present exemplary embodiment, the super-resolution processing is performed if the print resolution of the image is lower than 300 dpi.

In step S1305, the font setting unit 1204 sets the font pattern acquired from the font selection unit 216 to the image-corrected skeleton data acquired from the image correction unit 1203. FIG. 14C illustrates examples of the font combinations selected by the font selection unit 216. In the present exemplary embodiment, an example where the font pattern having a font ID of “2” in FIG. 14C is set to the image-corrected skeleton data will be described. In the present exemplary embodiment, the fonts are set to the character objects 1505, 1506, and 1507 of the skeleton 1508. In view of attractiveness, conspicuous fonts are often set for poster titles. Readable fonts are often set for other characters in view of visibility. In the present exemplary embodiment, the font selection unit 216 selects two types of fonts, or a title font and a body text font. The font setting unit 1204 sets the title font to the character object 1505 having the attribute “Title”, and the body text font to the other character objects 1506 and 1507. The font setting unit 1204 outputs the font-set skeleton data to the text arrangement unit 1205. While in the present exemplary embodiment the font selection unit 216 selects two types of fonts, this is not restrictive. For example, the font selection unit 216 may select only a title font. In such a case, the font setting unit 1204 uses a font corresponding to the title font as the body text font. In other words, a body text font matching the type of the title font may be set. For example, if the title font is a Gothic font, a typical readable Gothic font can be selected for the other character objects. If the title font is a Mincho font, a typical readable Mincho font can be selected for the other character objects. It will be understood that the title font and the body text font may be the same. Fonts can be used depending on the desired degree of conspicuousness. For example, a title font may be used for the title and subtitle character objects, and a body text font for the other character objects. A title font may be used for a certain font size or greater.

In step S1306, the text arrangement unit 1205 arranges the text designated by the text designation unit 202 on the font-set skeleton data acquired from the font setting unit 1204. In the present exemplary embodiment, the pieces of text illustrated in FIG. 14A are allocated with reference to the attributes of the metadata on the character objects in the skeleton. Specifically, “SUMMER THANKS SALE” having an attribute “Title” is allocated to the character object 1505, and “BEAT MIDSUMMER HEAT” having an attribute “Subtitle” is allocated to the character object 1506. No text is allocated to the character object 1507 since there is no body text. FIG. 15C illustrates a skeleton 1509 that is an example of the skeleton data having been processed by the text arrangement unit 1205. The text arrangement unit 1205 outputs the text-arranged skeleton data to the text decoration unit 1206.

In step S1307, the text decoration unit 1206 decorates the character objects in the text-arranged skeleton data acquired from the text arrangement unit 1205. In the present exemplary embodiment, the text decoration unit 1206 performs processing for outlining the title characters if a difference in color between the title characters and the background area is less than or equal to a threshold. This improves the readability of the title. The text decoration unit 1206 outputs the decorated skeleton data, specifically, the fully laid-out poster data to the impression estimation unit 218.

In step S1308, the layout unit 217 determines whether all pieces of poster data have been generated. If the layout unit 217 determines that poster data has been generated with all the combinations of the skeletons, coloration patterns, and font patterns (YES in step S1308), the layout processing ends. The processing proceeds to step S911. If the layout unit 217 determines that not all the pieces of poster data have been generated (NO in step S1308), the processing returns to step S1301 to generate poster data with an ungenerated combination.

The foregoing is the description of step S910. Return to FIG. 9A.

In step S911, the impression estimation unit 218 performs rendering processing on each piece of poster data acquired from the layout unit 217, estimates the impression of the rendered poster image, and links the estimated impression with the piece of poster data. The rendering processing refers to processing for converting poster data into image data. For example, even with the same coloration pattern, which color is actually used over how much area varies skeleton by skeleton since arrangements are different. The present processing is therefore performed at this timing because not only the impression tendency of the individual coloration patterns and skeletons but the impressions of the final outcomes of the posters are desirably assessed as well.

In such a manner, not only the impressions of the individual elements of the posters, such as coloration and arrangement, but the impressions of the final outcomes of the laid-out posters including the images and text are assessable as well.

In step S912, the poster selection unit 219 selects a poster to be output to the display 105 (to be presented to the user) based on the poster data acquired from the impression estimation unit 218 and the estimated impressions linked with the poster data. In the present exemplary embodiment, the poster selection unit 219 selects a poster of which the distance value between the target impression and the estimated impression is less than or equal to a predetermined threshold.

In the present exemplary embodiment, a Euclidean distance is used as the distance. The smaller the value indicated by the Euclidean distance, the closer the target impression and the estimated impression. The distance for the poster selection unit 219 to calculate is not limited to the Euclidean distance. Any vector-to-vector distance, such as a Manhattan distance and cosine similarity, can be calculated.

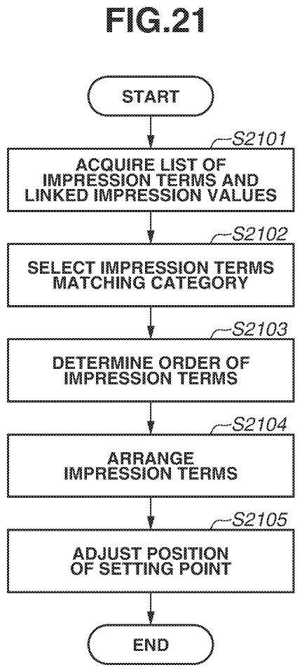

In step S913, the poster display unit 205 renders the poster data selected by the poster selection unit 219 and outputs the rendered poster image to the display 105. More specifically, the poster display unit 205 displays the poster preview screen 2301 of FIG. 23A. The arrangement of the impression terms on the operation UI is controlled based on the quantized impression values described above. The operation in Step S913 will be described in detail with reference to FIG. 21.

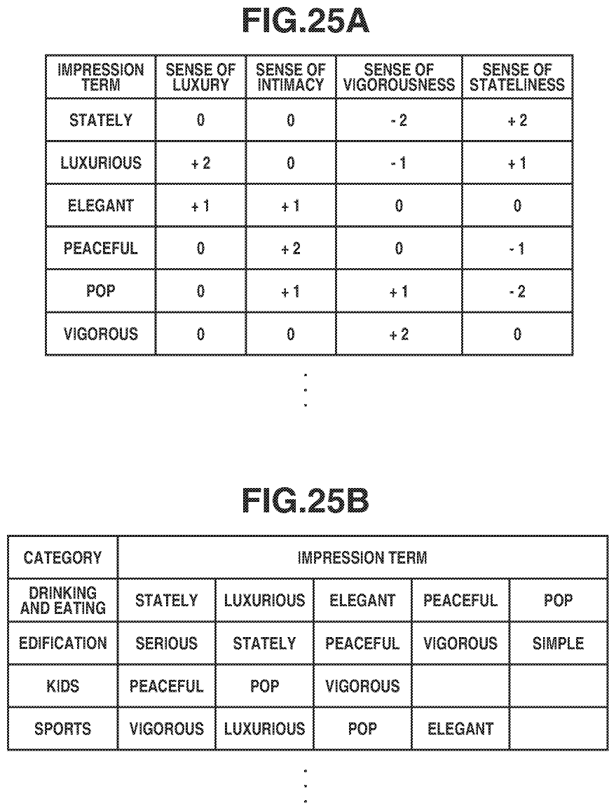

In step S2101, the poster display unit 205 acquires a list of impression terms and linked impression values stored in the HDD 104 in advance. FIG. 25A illustrates an example of the list of impression terms and linked impression values. The impression terms are listed on the vertical axis, and the impression values represented by the impression terms on the horizontal axis. For example, the impression term stately represents impression values of −2 in the sense of vigorousness and +2 in the sense of stateliness. In the present exemplary embodiment, the impression values are corrected to integer values of −2 to +2. The numerical values of −2, −1, 0, +1, and +2 indicate low, somewhat low, neither high or low, somewhat high, and high impressions, respectively. The purpose of correction into the range of −2 to +2 is to adjust the scale to that of the estimated impressions and facilitate distance calculation to be described below. However, this is not restrictive, and the impression values may be normalized to values of 0 to 1. The impression terms are selected from adjectives used in the SD method for poster impression quantization to be described below. The adjectives used in the SD method may be combined into ones well expressing the impressions of posters. The impression values corresponding to the impression terms are set based on factor analyses in the poster impression quantization to be described below. Posters matching the impression terms may be selected from the results of the foregoing poster questionnaire for the poster impression quantization, and the impression values may be set using those of the posters.

In step S2102, the poster display unit 205 selects impression terms matching the category designated by the poster generation condition designation unit 201 from the list of impression terms acquired in step S2101. FIG. 25B illustrates an example of a list of impression terms displayed by category. In FIG. 25B, impression terms for drinking and eating are “stately, luxurious, elegant, peaceful, and pop”. Impression terms for edification are “serious, stately, peaceful, vigorous, and simple”. Optimum impression terms can thus be displayed on the UI depending on the use application category, and posters desired by the user can be generated without tedious operations.

In step S2103, the poster display unit 205 determines the order of the impression terms selected in step S2102 based on the linked impression values. The impression values are regarded as constituting a multidimensional space, and the impression values are sorted to minimize the sum of the distances between the impression terms in the space. Here, the impression terms are sorted to minimize not only the differences between the impression values of adjoining impression terms but the differences between the impression values of the first and last impression terms as well.

A sum Lt of the distances between the impression terms in the space is calculated by using the following Eq. 3:

$${I}_{m , n} = [ \begin{matrix}{I}_{1 , 1} & … & {I}_{1 , N} \\ ⋮ & ⋱ & ⋮ \\ {I}_{M , 1} & … & {I}_{M , N}\end{matrix} ] \\ Lt = {\sum }_{n = 1}^{N} {( {I}_{1 , n} - {I}_{M , n} )}^{2} + {\sum }_{m = 1}^{M - 1} {\sum }_{n = 1}^{N} {( {I}_{m , n} - {I}_{m + 1 , n} )}^{2} , \qquad Eq . 3$$

where I is a two-dimensional array representing the impression terms and the corresponding impression values, N is the number of impression values, and M is the number of impression terms.

The sum Lt of the distances between the impression terms in the space is calculated while changing the vertical order in the two-dimensional array of I_{m,n}. For example, in the case of four impression terms luxurious, elegant, stately, and vigorous, there are three patterns of rosary permutations of order. The sums Lt of the distances between the terms in the space are calculated in the three patterns of order, and the order of the minimum sum Lt is determined. While the foregoing equation for calculating the sum Lt of the distances is one with equally weighted impression values, the impression values may be prioritized and weighted accordingly. While the foregoing equation for calculating the sum Lt of the distances in the multidimensional space calculates the distances in the multidimensional space by the sum of squares, the distances may be calculated by the mean sum of squares or the root sum of squares.

In step S2104, the poster display unit 205 arranges the impression terms on the ring-shaped operation UI based on the order of the impression terms determined in step S2103. The impression terms are arranged along the operation rail 2310. In FIG. 23A, the impression terms are arranged on the UI screen at equal distances, for example. The distances between the impression terms may be controlled based on the differences in the impression values of the impression terms calculated in step S2103. Specifically, if a difference in the impression values is large, the impression terms are arranged at a large distance. If a difference in the impression values is small, the impression terms are arranged close to each other. More specifically, suppose that the length of the operation rail 2310 is L, and the ratios of the distances between the impression terms are Lr(n, n+1) with the sum Lt of the distances between the impression terms in the space as 1. The first impression term in the order of the impression terms determined in step S2103 is located at the topmost position of the operation rail 2310 as a starting point. The second impression term is located at a position L×Lr(0, 1) away from the position where the first impression term is located on the locus along the circle of the operation rail 2310. The third impression term is located at a position L×Lr(1, 2) away from the position where the second impression term is located on the locus along the circle of the operation rail 2310. The same operation is repeated as many times as the number of impression terms. Through such processing, the impression terms can be arranged on the ring-shaped UI based on the differences in the impression values calculated in step S2103. When the setting point 2311 is moved on the operation rail 2310, the amount of movement of the setting point 2311 can thus be correlated with the amount of change in the target impression. This makes it easy to image a change in the generated poster and facilitates operating the impression of the generated poster.

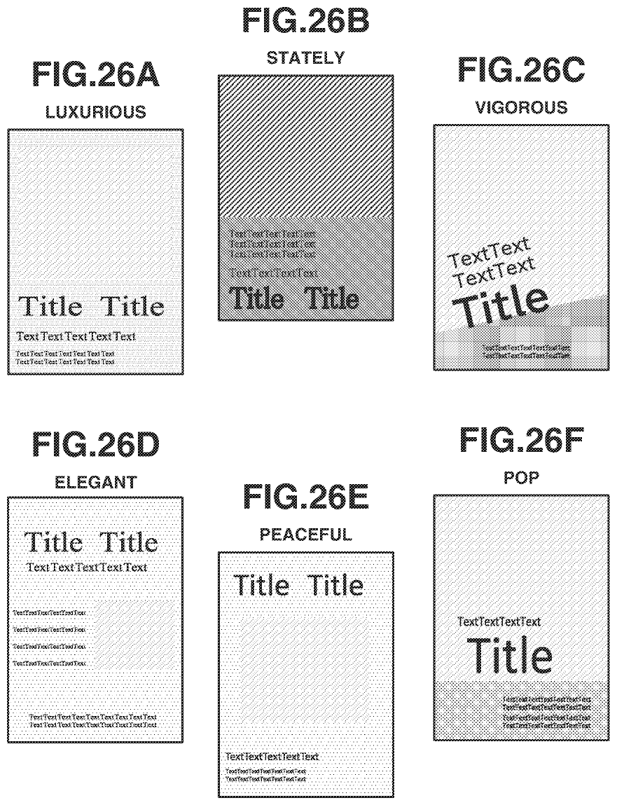

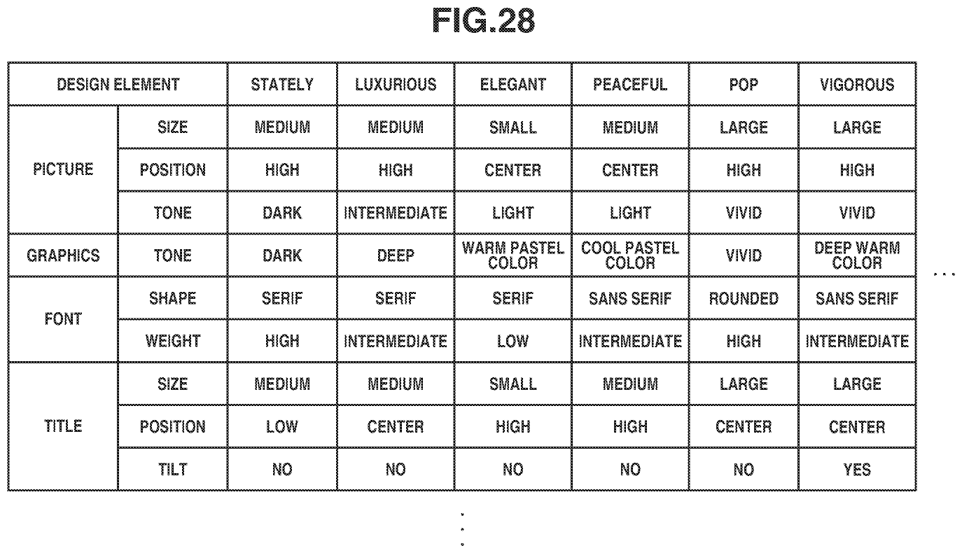

In step S2105, the poster display unit 205 adjusts the position of the setting point 2311 based on the target impression values with respect to the impression terms arranged in step S2104. Specifically, the poster display unit 205 compares the target impression with the impression values corresponding to the impression terms, selects the closest impression term, and displays the setting point 2311 at the position of the impression term. The poster display unit 205 may adjust the position of the setting point 2311 to a setting value between impression terms. Specifically, the poster display unit 205 compares the target impression with the impression values corresponding to the impression terms, and selects the closest impression term. The poster display unit 205 then compares the target value with the impression values corresponding to the impression terms on both sides of the closest impression term, and selects the closer impression term. With the sum of the distances between the target impression and the impression values corresponding to the two selected impression terms as 1, the poster display unit 205 then calculates a ratio Lrs of the distance between the target impression and the impression values corresponding to the closest impression term. With the distance between the two selected impression terms on the operation UI on the locus along the circle of the operation rail 2310 as Ls, the poster display unit 205 displays the setting point 2311 at a distance of Ls×Lrs from the closest impression term to the other impression term on the operation UI. Since the impression values corresponding to the impression terms arranged on the operation UI in step S913 are closely arranged, a change in design elements can be made linear as well. The reason is that a change in the impression values is strongly correlated with a change in the design elements. The design elements refer to elements constituting a poster in terms of design. Specific examples include the size and position of a picture area, a picture tone, a graphics tone, a font shape and weight, and a title size, position, and tilt. A description will be given with reference to FIG. 28. FIG. 28 is a chart illustrating a relationship of design elements with impression terms, using generated posters schematically illustrated in FIGS. 26A to 26F as an example. If, for example, the impression term is stately, the design elements for the poster to produce a stately impression are dark picture and graphics tones, a high-weight serif font, and a low title position. If the impression term is changed from stately to luxurious and elegant, the design element “picture tone” becomes gradually lighter. The design element “font weight” also becomes gradually lower. The order of the impression terms can thus be controlled so that the design elements do not change abruptly. This makes it easy to imagine the outcome of the design when the setting is changed to an adjoining impression term.

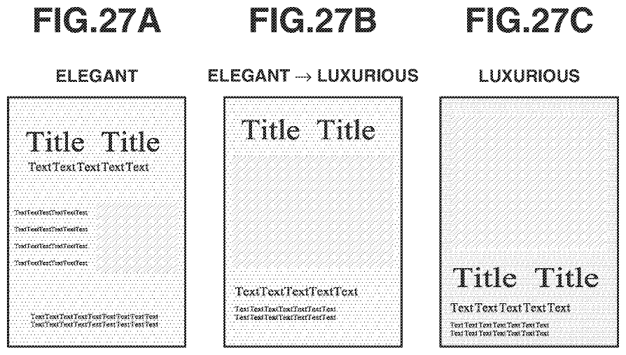

In step S914, the poster display unit 205 has the user operate the foregoing ring-shape operation UI to reset the target impression. In step S914, the poster display unit 205 resets the target impression in response to the operation of the setting point 2311 by the user. Here, the poster display unit 205 resets the target impression values based on the position of the setting point 2311 operated. Specifically, if target impressions settable using the ring-shaped operation UI are discrete and there are as many resettable candidate target impressions as the impression terms, the poster display unit 205 sets the impression values corresponding to the impression term to which the setting point 2311 is operated to move as the target impression. If target impressions settable using the ring-shaped operation UI have continuous values and the target impression is settable to between adjoining impression terms, the poster display unit 206 may reset the target impression by using interpolation calculation based on the distances between the adjoining impression terms and the setting point 2311. More specifically, suppose that two impression terms are located on the ring-shaped operation UI with the setting point 2311 therebetween, and the distances between the respective impression terms and the setting point 2311 on the UI are Ls1 and Ls2. A target impression Ir to be reset is given by Ir=Ls1/(Ls1+Ls2)×11+Ls2/(Ls1+Ls2)×12, where I1 and I2 are impression values of the two impression terms. Such interpolation calculation is performed for each impression value. While linear interpolation is performed here, bicubic interpolation may be performed using other adjacent impression values. How the generation result changes will be described in more detail by using setting values between elegant and luxurious as an example. If the setting point 2311 is set in between elegant and luxurious, the target impression has impression values intermediate between those of elegant and those of luxurious. Specifically, if the impression terms have the impression values illustrated in FIG. 25A, the target impression intermediate between elegant and luxurious has a sense of luxury of +1.5, a sense of intimacy of +0.5, a sense of vigorousness of −0.5, and a sense of stateliness of +0.5. A poster is generated with such a target impression. FIG. 27B is a diagram schematically illustrating the poster generated with the target impression intermediate between elegant and luxurious. Since the target impression has intermediate values, the poster is generated with intermediate design elements. Specifically, as illustrated in FIG. 28, the picture size becomes medium, and the graphics tone changes from deep to warm pastel color. While the foregoing description has dealt with only an intermediate point, this is not restrictive. For example, the interval between the impression terms may be subdivided into three or four equal parts.

The poster display unit 205 stores the reset target impression in the RAM 103.

In step S915, the poster display unit 205 determines whether to generate the poster to be displayed again or end the generation on the poster preview screen 2301. If the print button 2313 or the edit button 2312 is pressed (NO in step S915), the processing ends. If the target impression is reset in step S914 (YES in step S915), the processing proceeds to step S907.

FIGS. 26A to 26F are diagrams schematically illustrating posters generated using the impression values set with the setting point 2311. Areas hatched with diagonal lines ascending to the right represent picture areas. The density of the diagonal lines expresses the picture tone. The denser the darker tone. The thinner the lighter tone.

Dotted areas represent graphics. The density of the dots expresses the graphics tone. The thinner the dots, the lighter the tone. The denser the darker tone. For example, FIG. 26B illustrates a poster generated with the impression term “stately”. The poster of FIG. 26B includes a picture and graphics of dark tones, so that a high sense of stateliness is expressed. Generating posters matching the set impression terms makes it easy to imagine the generated posters and thus facilitates operating the impressions of the generated posters. Displaying the impression terms in such a manner makes it clear at a glance which setting value on the ring-shaped operation UI to use to generate a poster of the user-desired impression, and eliminates the need for tedious operations of repeatedly operating the impression values.

A comparison between the poster of FIG. 26B generated with the impression term “stately” and the poster of FIG. 26E generated with the impression term “peaceful” shows that the picture and graphics tones are opposite. The stately poster of FIG. 26B is generated in darker tones, and the peaceful poster of FIG. 26E in lighter tones. Similarly, the stately poster of FIG. 26B is generated with a low title position, and the peaceful poster of FIG. 26E a high title position. Even if the setting values are greatly changed, such a display makes it easy to imagine a change in the generated poster and facilitates operating the impression of the generated poster without tedious repetitive operations. The foregoing is the description of the poster generation processing procedure through which the user generates a poster by designating an impression.

As described above, the present exemplary embodiment enables generation of a poster expressing the user-desired impression without tedious repetitive operations. More specifically, in the present exemplary embodiment, a variety of candidate posters matching a target impression can be generated by combining elements of a poster, such as a skeleton, a coloration pattern, and a font pattern, based on the target impression. Moreover, a poster that produces an overall impression matching the user's intension, not just including such individual elements, can be generated by estimating the overall impression(s) of one or more candidate posters and selecting a poster close to the target impression. More specifically, suppose, for example, that the target impression set in the impression operation area 2303 on the poster preview screen 2301 according to the present exemplary embodiment has a sensor of luxury of −1, a sense of intimacy of +1, and a sense of vigorousness and a sense of stateliness of 0. In such a case, for example, the display area 2302 displays a poster generated with an estimated impression close to the target impression, like a sense of luxury of −1.2, a sense of intimacy of +0.9, a sense of vigorousness of +0.2, and a sense of stateliness of −1.3. Moreover, since the target impression is set using the ring-shaped operation UI in the impression operation area 2303, the plurality of impression values is settable at a time. The use of the impression terms makes it easy to imagine the generated poster, and posters with different impressions can thus be generated without tedious repetitive operations. Furthermore, arranging impression terms linked with similar impression values close to each other makes it easy to image the generated poster, and posters with different impressions can thus be generated without tedious repetitive operations. Arranging impression terms linked with similar impression values close to each other also makes it easy to imagine the generated poster since the design elements also change continuously. Posters with different impressions can thus be generated without tedious repetitive operations.

### Modification of First Exemplary Embodiment

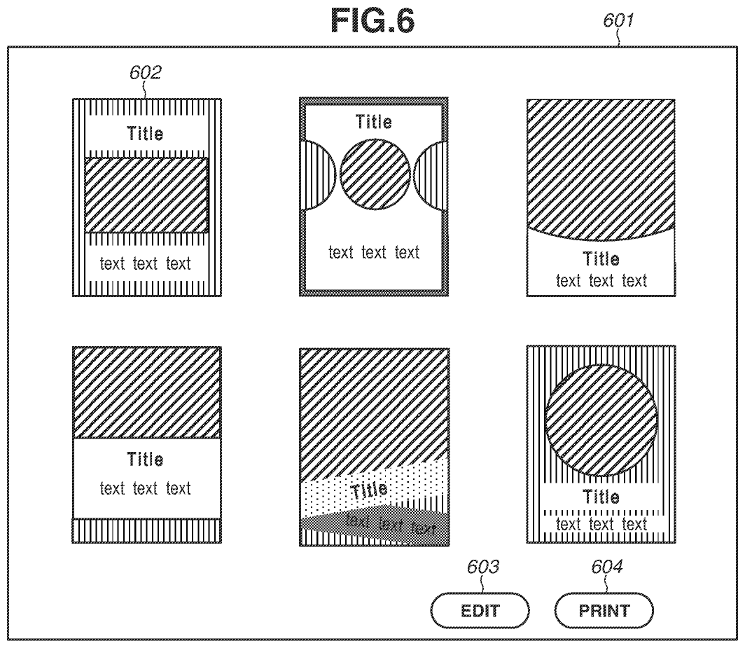

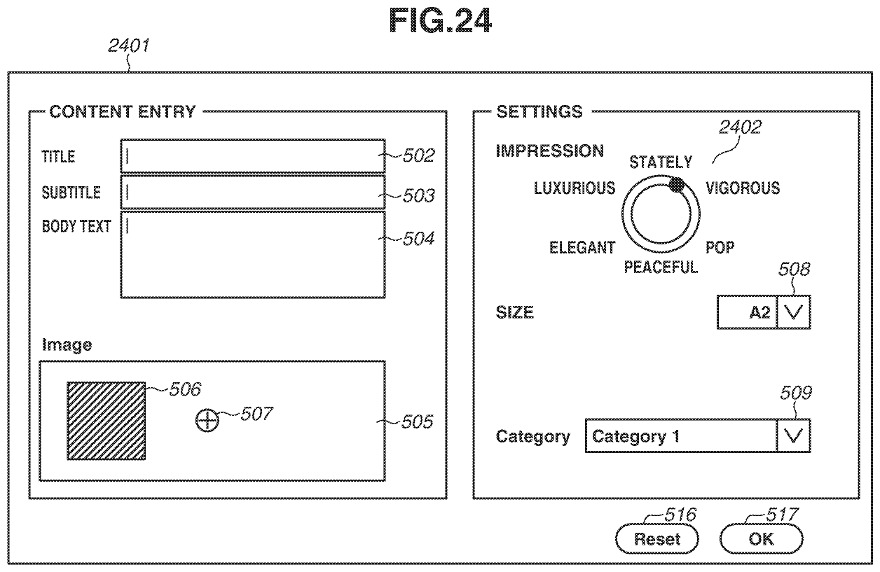

The foregoing screen transition described in the first exemplary embodiment is based on the impression values not being set on the app activation screen 501. Alternatively, the impression values may be set on the app activation screen as with the impression operation area 2303. FIG. 24 illustrates an example of a UI for setting the impression values on an app activation screen 2401, using a ring-shaped operation UI 2402. A target impression is determined from the impression term set using the ring-shaped UI 2402. A poster is generated based on the determined target impression. Here, a plurality of candidate posters may be generated and displayed as in FIG. 6.

FIG. 6 is a diagram illustrating an example of a poster preview screen 601 where poster images generated by the poster display unit 205 are displayed on the display 105. If an OK button 517 on the app activation screen 2401 is pressed to complete poster generation, the screen on the display 105 transitions to the poster preview screen 601.

Poster images 602 are candidate posters output by the poster display unit 205. Since the poster generation unit 210 generates posters as many as or more than the predetermined number of posters to be generated, the generated posters are listed on the poster preview screen 601 as the poster images 602. If the user clicks on a poster with the pointing device 107, the poster is selected.

An edit button 603 is used to edit the selected poster via a not-illustrated UI for providing an edit function.

A print button 604 is used to print the selected poster via a not-illustrated printer control UI.

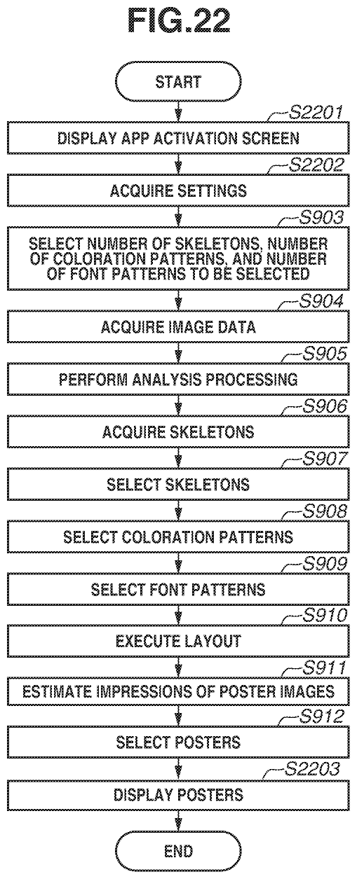

FIG. 22 is a flowchart illustrating processing by the poster generation unit 210 of the poster generation application according to the present exemplary embodiment. In the processing of this flowchart, steps denoted by the same step numbers as in the flowchart of FIG. 9A perform processing similar to that described in the first exemplary embodiment. A description thereof will thus be omitted. In the processing of this flowchart, steps S901, S902, and S913 to S915 illustrated in FIG. 9A are omitted.

In step S2201, the poster generation application displays the app activation screen 2401 on the display 105. The user inputs various settings via the UI of the app activation screen 2401 using the keyboard 106 and the pointing device 107. The poster generation application performs the processing illustrated in FIG. 21 to display the ring-shaped operation UI 2402.

In step S2202, the poster generation condition designation unit 201, the text designation unit 202, the image designation unit 203, and the target impression designation unit 204 acquire respective corresponding settings from the app activation screen 2401. The poster generation condition designation unit 201 performs processing similar to that of step S914 to designate target impression values.

In step S2203, the poster display unit 205 renders the poster data selected by the poster selection unit 219 and outputs poster images to the display 105. In other words, the poster display unit 205 displays the poster preview screen 601 of FIG. 6.

In such a manner, the ring-shaped operation UI 2402 and a plurality of candidate posters are displayed, so that posters desired by the user are generatable without tedious repetitive operations.

The app activation screen 2401 illustrated in FIG. 24 and the poster preview screen 2301 illustrated in FIG. 23A may be both used. If various settings are made on the app activation screen 2401 illustrated in FIG. 24 and then the OK button 517 is pressed to complete poster generation, the screen displayed on the display 105 transitions to the poster preview screen 2301. In such a case, the setting point 2311 on the poster preview screen 2301 is located at the same position as where the setting point is located on the ring-shaped operation UI 2402 of the app activation screen 2401.

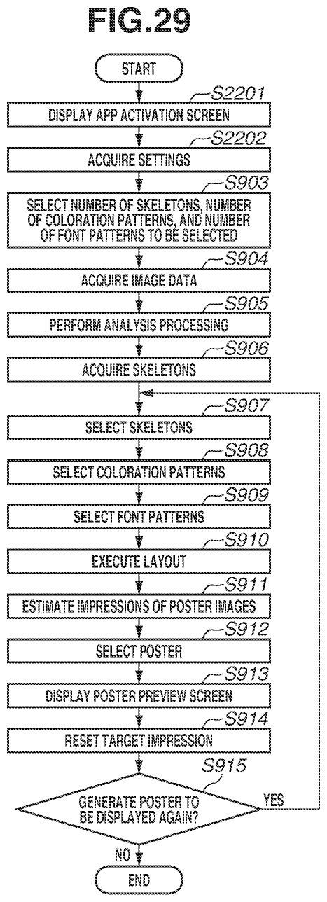

FIG. 29 is a flowchart illustrating processing by the poster generation unit 210 of the poster generation application according to the present exemplary embodiment. In the processing of this flowchart, steps denoted by the same step numbers as in the flowcharts of FIGS. 9A and 22 perform processing similar to the foregoing. A description thereof will thus be omitted. In the processing of this flowchart, steps S901 and S902 illustrated in FIG. 9A and step S2203 illustrated in FIG. 22 are omitted. This enables inheritance of the impression term set from the app activation screen 2401.

In step S913, a UI magnifying the position set on the ring-shaped UI 2402 of the app activation screen 2401 may be displayed as in FIG. 23B. This increases the distances between the impression terms on the UI and facilitates subtle settings. User-desired posters can thus be generated by easier operation. Here, the arrangement of the impression terms on the poster preview screen may be changed so that the setting point 2311 comes to the top of the ring-shaped operation UI. If the setting point 2311 comes to an end of the displayed operation rail, the arrangement of the impression terms on the poster preview screen may be controlled so that the impression term beyond is displayed. This enables a large change in the impression terms without a screen transition while enabling subtle settings.

While the target impression is set by using the ring-shaped operation UI 2402 of the app activation screen 2401 as the object to be operated for setting, the method for setting the target impression is not limited thereto.

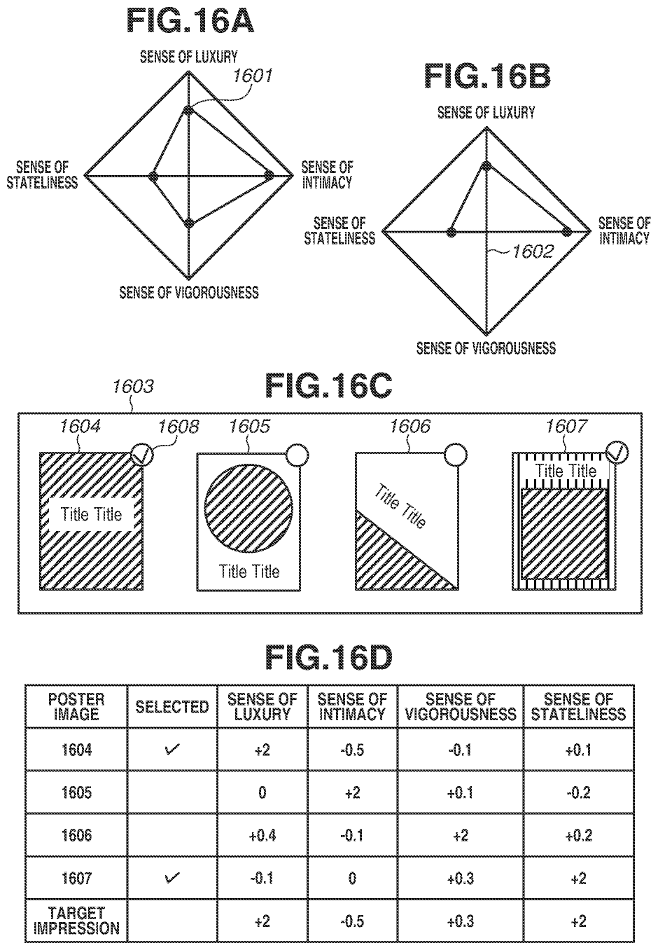

FIGS. 16A to 16D are diagrams illustrating examples of an UI for setting the target impression. FIG. 16A illustrates an example where the target impression is set using a UI on a radar chart. The impression values on the axes can be set by operating respective handles 1601 on the radar chart of FIG. 16A. For example, the target impression designation unit 204 acquires an impression value of −2 when the handle 1601 is located at the center of the UI, and +2 when the handle 1601 is located at the outermost position. In FIG. 16A, the target position is set to a sense of luxury of +0.8, a sense of intimacy of +1.1, a sense of vigorousness of −0.1, and a sense of stateliness of −0.7. The impression values may be decimal like these. The radar chart of FIG. 16B illustrates an example where some of the target impressions are off. For example, the user can double-click on a handle 1601 with the pointing device 107, so that the impression value on the axis to which the handle 1601 corresponds is turned off and hidden. The user can turn on and display the impression value again by clicking on the corresponding axis 1602 on the radar chart again with the pointing device 107. FIG. 16B illustrates a case where the sense of vigorousness is off and the impression values other than the sense of vigorousness are similar to those of FIG. 16A.

FIG. 16C illustrates an example of a UI for setting the target impression using images, not words. A sample poster display area 1603 includes poster images 1604 to 1607 where one of the impressions is high. A checkbox 1608 is displayed on each poster image. The user can turn on a checkbox 1608 to select a poster image that he/she considers close to the poster to be generated by clicking on the checkbox 1608. The target impression designation unit 204 determines the target impression by referring to the impression(s) corresponding to the selected poster image(s).

FIG. 16D is a table illustrating the impressions corresponding to the poster images 1604 and 1607 of FIG. 16C and the final target impression. Sense of luxury, sense of intimacy, sense of vigorousness, and sense of stateliness columns list numbers indicates how much effect each poster image has on the respective impressions. For example, suppose that the poster images 1604 and 1607 are selected as illustrated in FIG. 16C. In such a case, the target impression designation unit 204 determines the target impression in to which the respective impressions of the poster images 1604 and 1607. In this example, the maximum impression values in terms of absolute values among the numerical impression values of the respective factors corresponding to the selected poster images are used as the numerical values of the respective factors of the target impression. While the poster images of the respective maximum impressions are described to be presented, this is not restrictive. A poster image producing a plurality of high impressions may be used. Poster images as many as or more than the number of impressions may be presented. The user can thus intuitively designate a target impression using actual poster images, not words.

A second exemplary embodiment of the present disclosure will be described below. In the first exemplary embodiment, poster components, such as a skeleton, a coloration pattern, and a font pattern, are selected based on the target impression to generate a poster. In a second exemplary embodiment, a combination generation unit searches for combinations of poster components where the poster produces an overall impression similar to the target impression, based on genetic algorithms. Optimum poster components for the target impression can thereby be more flexibly selected without computing a skeleton impression table, a coloration pattern impression table, or a font impression table in advance.

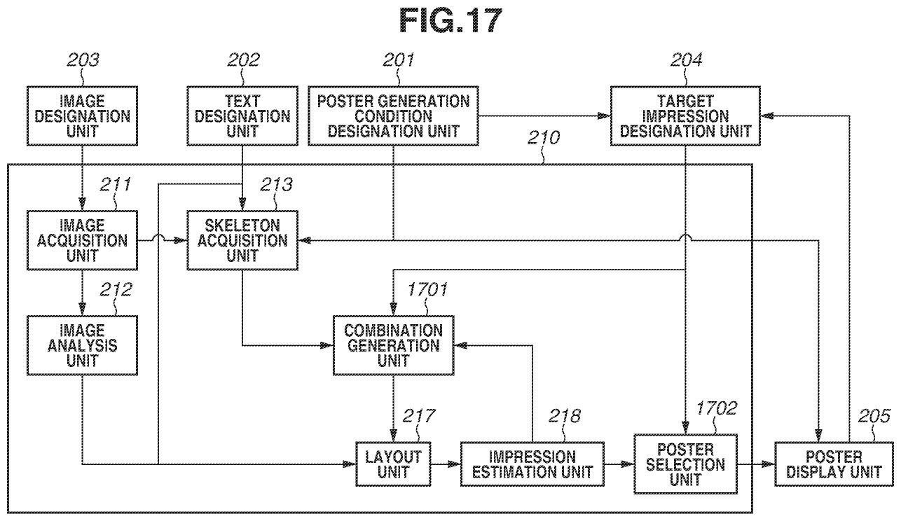

FIG. 17 is a software block diagram of a poster generation application according to the second exemplary embodiment. The configuration of the block diagram illustrated in FIG. 17 includes a combination generation unit 1701 instead of the skeleton selection unit 214, the coloration pattern selection unit 215, and the font selection unit 216 in FIG. 2. Components denoted by the same reference numerals as in FIG. 2 perform processing similar to that described in the first exemplary embodiment. A description thereof will thus be omitted.

The combination generation unit 1701 acquires one or more skeletons from the skeleton acquisition unit 213, poster data and estimated poster impressions from the impression estimation unit 218, and a target impression from the target impression designation unit 204. The combination generation unit 1701 also acquires a list of coloration patterns and a list of font patterns from the HDD 104. The combination generation unit 1701 generates combinations of the poster components (skeleton, coloration pattern, and font pattern) to be used for poster generation. The combination generation unit 1701 outputs the generated combinations of the poster components to the layout unit 217.

A poster selection unit 1702 selects posters of which a distance value between the estimated impression and the target impression designated by the target impression designation unit 204 is less than or equal to a threshold from the poster data acquired from the impression estimation unit 218, and stores the selected posters in the RAM 103. The poster selection unit 1702 also determines whether the number of posters selected and stored has reached the predetermined number of posters to be generated.

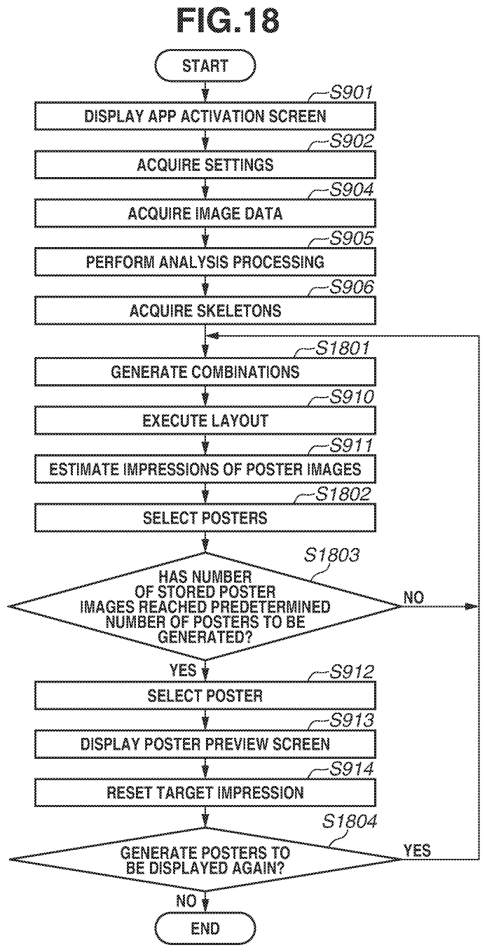

FIG. 18 is a flowchart illustrating the processing by the poster generation unit 210 of the poster generation application according to the present exemplary embodiment. In the processing of this flowchart, steps denoted by the same step numbers as in the flowchart of FIG. 9A perform processing similar to that described in the first exemplary embodiment. A description thereof will thus be omitted. In the processing of this flowchart, steps S903, S907 to S909, and S915 illustrated in FIG. 9A are omitted.

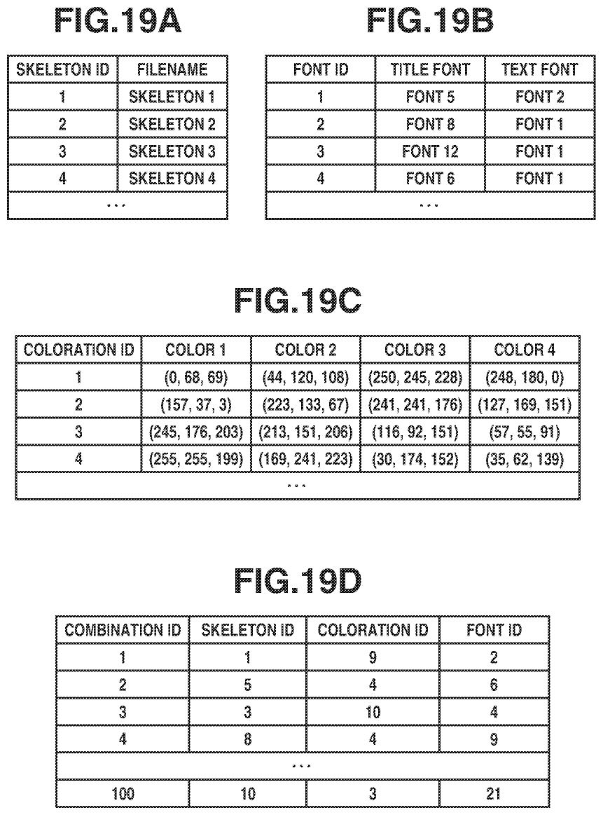

The operation of step S1801 performed for the first time and that for the second and subsequent loops after transition from step S1803 will be separately described. When step S1801 is performed for the first time, the combination generation unit 1701 acquires the tables of skeletons, coloration patterns, and font patterns to be used for poster generation. FIGS. 19A to 19D are charts for illustrating the tables used by the combination generation unit 1701.

FIG. 19A illustrates a list of skeletons that the combination generation unit 1701 acquires from the skeleton acquisition unit 213. FIGS. 19B and 19C illustrate a list of font patterns and a list of coloration patterns, respectively, that the combination generation unit 1701 acquires from the HDD 104. The combination generation unit 1701 generates combinations at random based on the foregoing three tables. In the present exemplary embodiment, the combination generation unit 1701 generates 100 combinations. FIG. 19D illustrates a table of combinations generated in the present exemplary embodiment.

The combination generation unit 1701 then performs the processing of steps S910, S911, and S1802 on all the generated combinations.

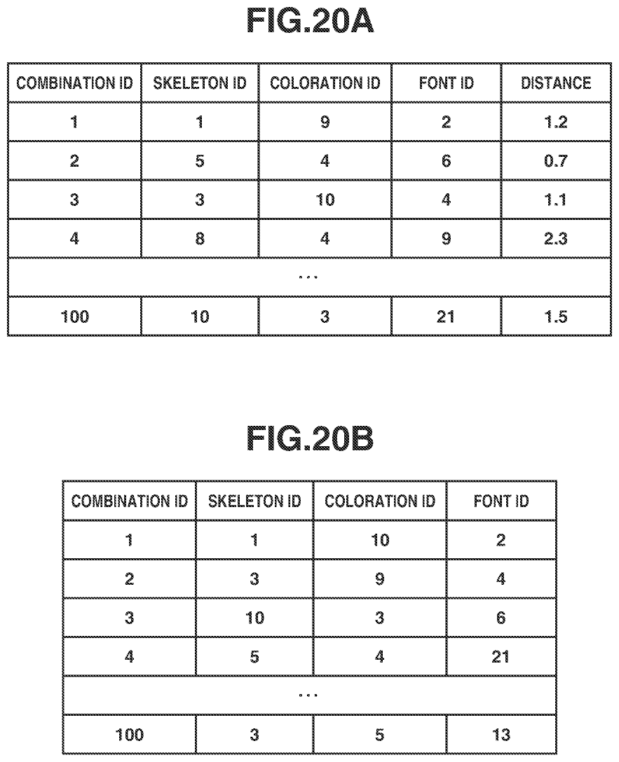

If step S1801 is performed in the second or subsequent loop, the combination generation unit 1701 calculates distance values between the estimated poster impressions acquired from the impression estimation unit 218 and the target impression, and links the distance values with the combination table. FIGS. 20A and 20B are charts for illustrating the operation of step S1801 in the second and subsequent loops. FIG. 20A is a table obtained by linking the combination table of FIG. 19D with the distance values between the estimated poster impressions and the target impression. More specifically, the layout unit 217 generates posters based on the combination table of FIG. 19D, and the impression estimation unit 218 estimates the impressions of the respective posters generated. A distance column of FIG. 20A lists the distance values between the estimated impressions of the posters generated with the combinations of the respective corresponding rows and the target impression. The combination generation unit 1701 generates a new combination table from the table of FIG. 20A. FIG. 20B illustrates the new combination table generated. In the present exemplary embodiment, the combination generation unit 1701 generates new combinations using tournament selection and uniform crossover in genetic algorithms. Initially, the combination generation unit 1701 selects N combinations from the table of FIG. 20A at random. Suppose here that N=3, for example. Next, the combination generation unit 1701 selects top two combinations of the smallest distances (closest to the target impression) from the selected combinations. Finally, the combination generation unit 1701 generates new combinations by interchanging respective combination elements (skeleton IDs, coloration IDs, or font IDs) in the two selected combinations at random. For example, combination IDs of 1 and 2 in FIG. 20B represent new combinations generated from the combinations with combination IDs of 1 and 3 in FIG. 20A. Here, the coloration IDs are interchanged. FIG. 20B illustrates 100 new combinations generated by repeating the foregoing procedure.

This enables efficient combination search based on the distance values between the target impression and the estimated impressions. While 100 combinations are generated in the present exemplary embodiment, this is not restrictive. While tournament selection and uniform crossover are used, this is not restrictive, either. Other methods such as ranking selection, roulette wheel selection, and one-point crossover may be used. Mutations may be incorporated to avoid local optimums. While skeletons (arrangements), coloration patterns, and font patterns are used as the poster components to be searched, other components may be used. For example, a plurality of patterns to be inserted into the background of a poster may be prepared, and which pattern to use or to not use may be determined by search. Increasing the components to be searched can help to generate more variety of posters and increase the breadth of impression expression.

In step S1802, the poster selection unit 1702 calculates the distance values between the estimated poster impressions and the target impression as in step S1801, and generates a table similar to that of FIG. 20A. The poster selection unit 1702 stores poster images of which the distance values from the target impression are less than or equal to a threshold into the RAM 103.

In step S1803, the poster selection unit 1702 determines whether the number of poster images stored in the RAM 103 has reached the predetermined number of posters to be generated. If the poster selection unit 1702 determines that the number of stored poster images has reached the predetermined number of posters to be generated (YES in step S1803), the processing proceeds to step S912. If the poster selection unit 1702 determines that the number of stored poster images has not reached the predetermined number of posters to be generated (NO in step S1803), the processing returns to S1801. In other words, the foregoing operation of step S1801 is performed for the second or subsequent loop. The processing from step S1801 to step S1802 is repeated until the number of poster images stored in the RAM 103, of which the distance values from the target impression are less than or equal to the threshold, reaches the predetermined number of posters to be generated. If poster images of which the distance values from the target impression are less than or equal to the threshold are stored more than the predetermined number of posters to be generated, the poster selection unit 1702 may compare the distance values of the respective poster images stored, and store only poster images of smaller values in the RAM 103. In such a case, poster images determined to have larger values based on the comparison results may be deleted from the RAM 103.

In step S1804, the poster selection unit 1702 determines whether to generate posters to be displayed again or end the generation on the poster preview screen 2301. If the print button 2313 or the edit button 2312 is pressed (NO in step S1804), the processing ends. If the target impression is reset in step S914 (YES in step S1804), the processing proceeds to step S1801.

While in the present exemplary embodiment the combinations of the poster components are searched by using genetic algorithms, the search technique is not limited thereto. Other search techniques such as local search and tabu search may be used.

As described above, according to the present exemplary embodiment, a poster producing an overall impression similar to the target impression can be generated by searching for combinations of components to be used in the poster. Such a technique is particularly effective in generating posters based on images and character information input by the user. Suppose, for example, images are vigorous but the user wants to generate a poster giving a peaceful impression overall. In the present exemplary embodiment, a combination of a skeleton, a coloration pattern, and a font pattern to approach the target impression can be searched for by assessing the overall impressions of posters. To reduce the effect of the impressions of the images, the components of the poster can be controlled depending on the images, like using a skeleton with small image areas or using more subdued fonts or coloration. According to the present exemplary embodiment, optimum combinations of components for the overall impression of a poster can be flexibly searched for, and a variety of posters close to the target impression can be generated.

### Other Exemplary Embodiments

In the foregoing exemplary embodiments, automatic poster generation has been described as an example. However, automatic generation can also be implemented in designing other advertising media. Specifically, for example, postcards, menus, and trifold leaflets can be automatically generated like posters through similar processing by the skeleton acquisition unit 213 managing skeletons for the intended design.

The foregoing exemplary embodiments can also be implemented by performing the following processing. The processing includes supplying software (program) for implementing the functions of the foregoing exemplary embodiments to a system or an apparatus via a network or various storage media, and reading and executing the program by a computer (CPU or microprocessing unit [MPU]) of the system or apparatus. The program may be executed by a single computer or by cooperation of a plurality of computers. All the foregoing processing does not need to be implemented by software, and part or all of the processing may be implemented by hardware, such as an application-specific integrated circuit (ASIC). The CPU is not limited to one that performs all the processing by itself, and a plurality of CPUs may perform the processing in cooperation as appropriate. The functions of the foregoing exemplary embodiments are not necessarily implemented simply by the computer executing the read program code. The foregoing exemplary embodiments also cover cases where an OS running on the computer performs part or all of the actual processing based on the instructions of the program code, and the functions of the foregoing exemplary embodiments are implemented by such processing.

According to an exemplary embodiment of the present disclosure, a poster expressing a user-intended impression can be generated by appropriate and simple operations.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-026875, filed Feb. 24, 2023, which is hereby incorporated by reference herein in its entirety.

What is claimed is:

1. An information processing apparatus comprising:
an image input unit configured to input an image;
a character input unit configured to input a character;
an acceptance unit configured to accept designation of a target impression by a user; and
a poster generation unit configured to generate a poster based on the image, the character, and the target impression,
wherein the acceptance unit is configured to accept the designation of the target impression by the user via a ring-shaped operation user interface (UI).

2. The information processing apparatus according to claim 1, wherein the ring-shaped operation UI includes a plurality of impression terms arranged in a ring configuration.

3. The information processing apparatus according to claim 2,
wherein the plurality of impression terms includes at least a first impression term, a second impression term, and a third impression term, and
wherein the ring-shaped operation UI includes the first and second impression terms that are arranged next to each other and the first and third impression terms that are not arranged next to each other.

4. The information processing apparatus according to claim 3, wherein a difference between an impression value of a poster generated with the first impression term and an impression value of a poster generated with the second impression term is smaller than a difference between the impression value of the poster generated with the first impression term and an impression value of a poster generated with the third impression term.

5. The information processing apparatus according to claim 3, wherein the poster generation unit is configured to cause a linear change in a design element of a poster generated with the first impression term and that of a poster generated with the second impression term.

6. The information processing apparatus according to claim 5, wherein the design element is at least one of the following: a picture size, a picture position, a color tone after picture processing, a graphics tone, a font shape, a font weight, a title size, a title position, and a title tilt.

7. The information processing apparatus according to claim 2, wherein the impression terms express impressions a poster gives.

8. The information processing apparatus according to claim 2, wherein the impression terms include at least one of the following: stately, vigorous, pop, peaceful, elegant, and luxurious.

9. The information processing apparatus according to claim 1, wherein the target impression is determined by a combination of factors representing impressions.

10. The information processing apparatus according to claim 1, wherein poster images with different target impressions are generated if the poster images differ in coloration.

11. The information processing apparatus according to claim 1, wherein poster images with different target impressions are generated if the poster images include the character and differ in a font of the character.

12. The information processing apparatus according to claim 1, wherein poster images with different target impressions are generated if the poster images include the character or the image and differ in a method of arrangement of the character or the image.

13. The information processing apparatus according to claim 1, wherein information indicating a difference between an impression the poster generated by the poster generation unit produces and the designated target impression is less than a predetermined threshold.

14. The information processing apparatus according to claim 1,
wherein a poster image is generated based on a skeleton, the skeleton being information indicating arrangement of the character, the image, and graphics in the poster image, and
wherein poster images with different target impressions are generated if the skeleton varies.

15. The information processing apparatus according to claim 14, wherein the poster image is generated with the character and the image arranged on a template into which the skeleton is combined with coloration and a character font in the poster image in advance.

16. The information processing apparatus according to claim 14, wherein a skeleton close to the target impression and coloration and a character font in the poster image are separately selected and the poster image is generated based on a combination of the selected skeleton with the selected coloration and the selected character font in the poster image.

17. A method for controlling an information processing apparatus, comprising:
inputting an image;
inputting a character;
accepting designation of a target impression by a user; and
generating a poster based on the image, the character, and the target impression,
wherein the designation of the target impression by the user is accepted via a ring-shaped operation UI.

18. A non-transitory computer-readable storage medium storing computer-executable instructions that, when executed by a computer, cause the computer to perform a control method, the control method comprising:
inputting an image;
inputting a character;
accepting designation of a target impression by a user; and
generating a poster based on the image, the character, and the target impression,
wherein the designation of the target impression by the user is accepted via a ring-shaped operation UI.
